(19) United States
(12) Patent Application Publication
(10) Pub. No.: US 2023/0368121 A1
(43) Pub. Date: Nov. 16, 2023

(54) SYSTEM AND METHOD FOR ENHANCED ESTIMATED TIME OF ARRIVAL FOR VESSELS

(71) Applicant: Global Spatial Technology Solutions Inc.

(72) Inventors: Juan Manuel Carrillo Garcia, London (CA); Diana Carolina Borda Beltran, Montreal (CA); Katherine Borda Ceballos, London (CA); Benjamin Kurtis Friedrich, Halifax (CA); William Edward Hipson, Dartmouth (CA); Daniel de Oliveira Arantes, Dartmouth (CA); Ana Luisa Alfaro Suzan, North York (CA)

(21) Appl. No.: 17/742,176

(22) Filed: May 11, 2022

(51) Int. Cl. G06Q 10/08; G06Q 50/30

(52) U.S. Cl. CPC G06Q 10/0831; G06Q 10/0833; G06Q 50/30

(57) ABSTRACT

Provided are systems and methods for determining an estimated time of arrival for one or more vessels based on vessel tracking data, and systems and methods for generating an estimated time of arrival model. This includes providing, at a memory, an estimated time of arrival model and a plurality of port boundaries; receiving, at a processor in communication with the memory, vessel data corresponding to at least one vessel, the vessel data comprising vessel location data and secondary data; receiving, at a network device in communication with the processor, an estimated time of arrival request; in response to the estimated time of arrival request, determining an estimated time of arrival corresponding to at least one vessel based on the vessel data and the estimated time of arrival model; and outputting, at an output device in communication with the processor, the estimated time of arrival for the at least one vessel.

### FIELD

The described embodiments relate to determining an estimated time of arrival for a vessel, and specifically to analyzing vessel tracking data in order to determine the estimated time of arrival of a vessel.

### BACKGROUND

Global shipping poses many risks, including national security risks, risks related to communicable diseases, supply chain disruptions, and variable costs (including loading/unloading costs and insurance costs). Coast guard and naval resources are limited because the regions they are responsible for monitoring and protecting are very large, and not every vessel can be inspected.

Shipping vessels are tracked using vessel tracking devices such as Automatic Identification Systems (AIS) that include vessel-based transceiver systems. Each vessel transmits data including unique identification, position, course, and speed, amongst other things. The vessel may receive and display this information on an electronic chart display and information system (ECDIS). Shore-based tracking can include AIS base stations, and vessel traffic services (VTS) that may be provided at a harbor or port which provide functionality similar to air traffic control systems for aircraft.

AIS transceivers have been mandatory since the International Maritime Organization’s (IMO) International Convention for the Safety of Life at Sea (SOLAS) for international voyaging ships with 300 or more gross tonnage (GT), and all passenger ships regardless of size. AIS has been implemented first as a terrestrial-based system (T-AIS) and later as a satellite-based system (S-AIS).

AIS data may be used to track vessels. AIS itself provides an Estimated Time of Arrival (ETA) for a Vessel, but the AIS ETA information for a vessel is self-reported by the vessel and may be unreliable.

Stakeholders in the context of shipping and port logistics experience excessive costs due to uncertainty in the arrival of vessels, including the contract costs that are incurred when vessels do not arrive on time and are scheduled for refueling, repair, or loading/unloading.

A vessel that arrives later than expected causes idle port resources that could have otherwise be used to handle other vessels. There is also a ripple effect on other parts of the supply chain (e.g., including cranes, trains, trucks) when a vessel contains shipping containers or other logistical items that are to be shipped using another mode of transport.

A vessel that arrives earlier than expected often has to wait at an anchorage area while the port allocates resources to handle its cargo. This causes idle time for the vessel itself that could have otherwise be spent to navigate towards the next port. It may also include fuel costs, since vessels that have to wait could have alternately travelled slower and incurred lower fuel use.

At any given time, there are thousands of vessels navigating between hundreds of ports around the world, and a comparable number of stakeholders involved, all of whom are interacting in the distributed economy. To make things even more complicated, stakeholders have little to no control over some factors that significantly impact vessel traffic, such as weather conditions or fuel prices.

Every port is unique due to its geographic layout, the regulations that apply in its jurisdiction, and the specific operational capabilities if offers, such as oil or container terminals. The characteristics of each port add even more complexity to the calculation of accurate ETAs. Moreover, approaching the same port from different source locations could take significantly more or less time depending on predictable activities, like passing through a canal, or highly dynamic ones, like weather conditions.

Existing estimated time of arrival (ETA) systems for vessels have many limitations that can include limitations due to small scope and data samples, limitations due to the design of existing predictive models, and limitations based on faulty assumptions.

First, limitations due to small scope and data samples can include limitations due to the manual preparation of the datasets. Also, since there may be only a few ports used for an existing ETA model, experimental evaluation may be difficult. In such situations, the predictions of a model may not generalize to many ports. The use of fixed training datasets, without considerations about how to update them, may pose other issues as data becomes out of date.

Second, limitations may exist due to the design and development of existing predictive models. Including the use a fixed set of input variables to the model, the use only a few input variables, or the use of a few biased models. The manual selection of input variables, and manual evaluation and selection of one predictive model may result in inaccurate or low quality predictions. Finally, existing model may lack a consistent evaluation approach and may not compare predictions to ground truth arrivals data as a means of feedback.

Third, limitations due to weak assumptions in the design and implementation of ETA systems. These can include systems that do not account for dynamic weather conditions, systems that assume that every port could use the same model, systems that assume vessels move at constant speed, and systems that consider weather only at a vessels’ instantaneous location.

There is a need therefore for port authorities, national governments, public health organizations, and shipping companies to be able to quickly and accurately assess vessel estimated time of arrival. For at least these reasons, there exists a need for an improved system and method for determining vessel estimated time of arrival.

### SUMMARY

Provided are systems, methods, and computer readable media for determining vessel ETA which uses real time data, and may generate an output enhanced ETA generally in real time.

The enhanced ETA may automatically determine related data for a plurality of ports or other points of vessel origination or destination. This may include for each port or destination area, automatically obtaining and periodically updating training data, automatically training and evaluating multiple machine learning or statistical models, automatically determining an appropriate machine learning or statistical model from a plurality of models, automatically incorporating weather data along the route to destination, and determining automatically when updates are required to the machine learning or statistical models.

This may improve systems, methods, and computer readable media in the field of machine learning and statistical models because the process is increasingly more automatic, there may be less human intervention and possibility for error, and model may be automatically adapted or evolved depending on available input data. This is complemented by the ability to easily determine or augment datasets for training. This may result in improvements in the accuracy of ETA predictions.

In a first aspect, there is provided a computer-implemented method for determining an estimated time of arrival for a vessel, the method comprising: providing, at a memory, an estimated time of arrival model and a plurality of port boundaries; receiving, at a processor in communication with the memory, vessel data corresponding to at least one vessel, the vessel data comprising vessel location data and secondary data; receiving, at a network device in communication with the processor, an estimated time of arrival request; in response to the estimated time of arrival request, determining an estimated time of arrival corresponding to at least one vessel based on the vessel data and the estimated time of arrival model; outputting, at an output device in communication with the processor, the estimated time of arrival for the at least one vessel.

In one or more embodiments, the estimated time of arrival request may comprise a vessel identifier.

In one or more embodiments, the estimated time of arrival request may comprise a port identifier and the estimated time of arrival is determined for one or more vessel having a destination corresponding to the port identifier.

In one or more embodiments, the estimated time of arrival corresponding to the at least one vessel may comprise a remaining time of travel.

In one or more embodiments, the vessel location data may comprise geospatial data and the secondary data comprises alphanumeric data, and the geospatial data is joined with the alphanumeric data prior to the determining the estimated time of arrival corresponding to the at least one vessel.

In one or more embodiments, the secondary data may comprise alphanumeric data comprising vessel type data, port congestion data, vessel tonnage data.

In one or more embodiments, the determining the estimated time of arrival corresponding to at least one vessel based may be further based on a port boundary.

In one or more embodiments, the port boundary may comprise a closed polygon corresponding to the port identifier.

In one or more embodiments, the estimated time of arrival model may comprise a plurality of sub-models, each of the plurality of sub-models corresponding to a port.

In one or more embodiments, a sub-model in the plurality of sub-models may comprise a regression model, and the determined remaining time of travel for a corresponding port to the sub-model may be determined by the regression model based on the vessel data.

In one or more embodiments, the regression model may comprise one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

In one or more embodiments, the received historical vessel tracking data may comprise at least one of received AIS data and received radiofrequency beacon data.

In one or more embodiments, the output device may comprise at least one of an audio output device or a video output device.

In one or more embodiments, the time of arrival may be for one or more arbitrary locations in the open ocean or ocean-feeding lake or river in sequence.

In a second aspect, there is provided a system for determining an estimated time of arrival for a vessel, the system comprising: a memory comprising an estimated time of arrival model and a plurality of port boundaries; an output device; a processor in communication with the memory and the output device, the processor configured to: receive vessel data corresponding to at least one vessel, the vessel data comprising vessel location data and secondary data; receive an estimated time of arrival request; in response to the estimated time of arrival request, determine an estimated time of arrival corresponding to at least one vessel based on the vessel data and the estimated time of arrival model; output, to the output device in communication with the processor, the estimated time of arrival for the at least one vessel.

In one or more embodiments, the estimated time of arrival request may comprise a vessel identifier.

In one or more embodiments, the estimated time of arrival request may comprise a port identifier and the estimated time of arrival is determined for one or more vessel having a destination corresponding to the port identifier.

In one or more embodiments, the estimated time of arrival corresponding to the at least one vessel may comprise a remaining time of travel.

In one or more embodiments, the vessel location data may comprise geospatial data and the secondary data comprises alphanumeric data, and the geospatial data may be joined with the alphanumeric data prior to the determining the estimated time of arrival corresponding to the at least one vessel.

In one or more embodiments, the secondary data may comprise alphanumeric data comprising vessel type data, port congestion data, vessel tonnage data.

In one or more embodiments, the determining the estimated time of arrival corresponding to at least one vessel based may be further based on a port boundary.

In one or more embodiments, the port boundary may comprise a closed polygon corresponding to the port identifier.

In one or more embodiments, the estimated time of arrival model may comprise a plurality of sub-models, each of the plurality of sub-models corresponding to a port.

In one or more embodiments, a sub-model in the plurality of sub-models may comprise a regression model, and the determined remaining time of travel for a corresponding port to the sub-model is determined by the regression model based on the vessel data.

In one or more embodiments, the regression model may comprise one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

In one or more embodiments, the received historical vessel tracking data may comprise at least one of received AIS data and received radiofrequency beacon data.

In one or more embodiments, the output device may comprise at least one of an audio output device or a video output device.

In one or more embodiments, the processor may be applied to predict the time of arrival to one or more arbitrary locations in the open ocean or ocean-feeding lake or river in sequence.

In a third aspect, there is provided a computer-implemented method for generating an estimated time of arrival model, the method comprising: receiving, at a processor, vessel data for a plurality of vessels, the vessel data comprising historical vessel location data and historical secondary data; determining, at the processor, a plurality of port boundaries; determining, at the processor, a plurality of vessel trips in the vessel data based on the plurality of port boundaries, each of the plurality of vessel trips comprising a plurality of vessel location messages; determining, at the processor, at least one feature corresponding to the vessel location messages of each of the plurality of vessel trips; generating, at the processor, an estimated time of arrival model based on the plurality of vessel trips, and the at least one input feature corresponding to the vessel location messages of the plurality of vessel trips; and storing the estimated time of arrival model in a memory in communication with the processor.

In one or more embodiments, the plurality of port boundaries may correspond to at least one of a port, an anchorage, or a maintenance facility.

In one or more embodiments, the determining the plurality of port boundaries may comprise determining the plurality of port boundaries from at least one of a map, a digital satellite image, a digital aerial photograph, and geospatial data.

In one or more embodiments, the determining the plurality of port boundaries may comprise determining the plurality of port boundaries based on historical vessel tracking data.

In one or more embodiments, each of the plurality of port boundaries may comprise at least one polygon.

In one or more embodiments, the at least one polygon may comprise at least two hierarchical levels.

In one or more embodiments, the at least one feature may comprise a remaining time of travel.

In one or more embodiments, each of the vessel trips may comprise an origin port identifier, a destination port identifier.

In one or more embodiments, the method may further comprise: determining, at the processor, a remaining time of travel for each of the plurality of vessel location messages by: identifying the plurality of vessel trips in the historical vessel location data corresponding to the destination port identifier; determining an actual time of arrival for each of the plurality of vessel trips in the historical vessel location data corresponding to the destination port identifier, wherein for each identified vessel trip the actual time of arrival comprises a timestamp corresponding to the vessel entering a destination port boundary associated with the destination port identifier; determining the remaining time of travel for each of the plurality of vessel location messages based on a timestamp associated with each vessel location message and the actual time of arrival for the associated vessel trip, the remaining time of travel comprising a period of time until the vessel arrives at a destination.

In one or more embodiments, the actual time of arrival may be determined by: using a spatial selection algorithm to identify at least one vessel location message inside and at least one vessel location message outside of the destination port boundary; sorting the at least one vessel trip location message by its timestamp; selecting the last vessel trip location message of the vessel trip outside the destination port boundary, and the first vessel trip location message inside the port boundary; and applying a weighted interpolation of the timestamps of those two vessel location messages as the actual time of arrival.

In one or more embodiments, the method may further comprise: determining a plurality of vessel trip groups, each comprising a subset of the plurality of vessel trips wherein each vessel trip in the subset has the same origin port identifier and the same destination port identifier.

In one or more embodiments, the estimated time of arrival model may comprise a plurality of sub-models, each of the plurality of sub-models corresponding to a port.

In one or more embodiments, a sub-model in the plurality of sub-models may comprise a regression model, and the determined remaining time of travel for a corresponding port to the sub-model may be determined by the regression model based on the vessel data.

In one or more embodiments, the regression model may comprise one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

In one or more embodiments, the received historical vessel tracking data may comprise at least one of received AIS data and received radiofrequency beacon data.

In one or more embodiments, the method may further comprise: determining, at the processor, that a first temporal resolution of the historical vessel location data and a second temporal resolution of the historical secondary data are different; and interpolating one of the historical vessel location data and the historical secondary data.

In one or more embodiments, the interpolating may comprise interpolating the historical vessel location data corresponding to each of the plurality of vessel trips based on the historical secondary data, and wherein the historical vessel location data may have a first temporal resolution and the historical secondary data may have a second temporal resolution, the first temporal resolution lower than the second temporal resolution.

In one or more embodiments, the interpolating may comprise interpolating the historical secondary data corresponding to each of the plurality of vessel trips based on the historical vessel location data, and wherein the historical vessel location data may have a first temporal resolution and the historical secondary data may have a second temporal resolution, the first temporal resolution higher than the second temporal resolution.

In a fourth aspect there is provided a system for generating an estimated time of arrival model, the system comprising: a memory; a processor in communication with the memory, the processor configured to: receive vessel data for a plurality of vessels, the vessel data comprising historical vessel location data and historical secondary data; determine a plurality of port boundaries; determine a plurality of vessel trips in the vessel data based on the plurality of port boundaries, each of the plurality of vessel trips comprising a plurality of vessel location messages; determine at least one feature corresponding to the vessel location messages of each of the plurality of vessel trips; generating an estimated time of arrival model based on the plurality of vessel trips, and the at least one input feature corresponding to the vessel location messages of the plurality of vessel trips; and storing the estimated time of arrival model in a memory in communication with the processor.

In one or more embodiments, the plurality of port boundaries may correspond to at least one of a port, an anchorage, or a maintenance facility.

In one or more embodiments, the processor may be further configured to determine the plurality of port boundaries by determining the plurality of port boundaries from at least one of a map, a digital satellite image, a digital aerial photograph, and geospatial data.

In one or more embodiments, the processor may be further configured to determine the plurality of port boundaries by determining the plurality of port boundaries based on historical vessel tracking data.

In one or more embodiments, each of the plurality of port boundaries may comprise at least one polygon.

In one or more embodiments, the at least one polygon may comprise at least two hierarchical levels.

In one or more embodiments, the at least one feature may comprise a remaining time of travel.

In one or more embodiments, each of the vessel trips may comprise an origin port identifier, a destination port identifier.

In one or more embodiments, the processor may be further configured to: determine a remaining time of travel for each of the plurality of vessel location messages by: identifying the plurality of vessel trips in the historical vessel location data corresponding to the destination port identifier; determining an actual time of arrival for each of the plurality of vessel trips in the historical vessel location data corresponding to the destination port identifier, wherein for each identified vessel trip the actual time of arrival comprises a timestamp corresponding to the vessel entering a destination port boundary associated with the destination port identifier; and determining the remaining time of travel for each of the plurality of vessel location messages based on a timestamp associated with each vessel location message and the actual time of arrival for the associated vessel trip, the remaining time of travel comprising a period of time until the vessel arrives at a destination.

In one or more embodiments, the processor may be further configured to determine the actual time of arrival by: using a spatial selection algorithm to identify at least one vessel location message inside and at least one vessel location message outside of the destination port boundary; sorting the at least one vessel trip location message by its timestamp; selecting the last vessel trip location message of the vessel trip outside the destination port boundary, and the first vessel trip location message inside the port boundary; and applying a weighted interpolation of the timestamps of those two vessel location messages as the actual time of arrival.

In one or more embodiments, the processor may be further configured to: determine a plurality of vessel trip groups, each comprising a subset of the plurality of vessel trips wherein each vessel trip in the subset has the same origin port identifier and the same destination port identifier.

In one or more embodiments, the estimated time of arrival model may comprise a plurality of sub-models, each of the plurality of sub-models corresponding to a port.

In one or more embodiments, a sub-model in the plurality of sub-models may comprise a regression model, and the determined remaining time of travel for a corresponding port to the sub-model is determined by the regression model based on the vessel data.

In one or more embodiments, the regression model may comprise one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

In one or more embodiments, the received historical vessel tracking data may comprise at least one of received AIS data and received radiofrequency beacon data.

In one or more embodiments, the processor may be further configured to: determine, at the processor, that a first temporal resolution of the historical vessel location data and a second temporal resolution of the historical secondary data may be different; and interpolating one of the historical vessel location data and the historical secondary data.

In one or more embodiments, the interpolating may comprise interpolating the historical vessel location data corresponding to each of the plurality of vessel trips based on the historical secondary data, and wherein the historical vessel location data has a first temporal resolution and the historical secondary data may have a second temporal resolution, the first temporal resolution lower than the second temporal resolution.

In one or more embodiments, the interpolating may comprise interpolating the historical secondary data corresponding to each of the plurality of vessel trips based on the historical vessel location data, and wherein the historical vessel location data may have a first temporal resolution and the historical secondary data may have a second temporal resolution, the first temporal resolution higher than the second temporal resolution.

### BRIEF DESCRIPTION OF THE DRAWINGS

A preferred embodiment will now be described in detail with reference to the drawings, in which:

FIG. 1 shows a system diagram of a system for vessel estimated time of arrival assessment in accordance with one or more embodiments.

FIG. 2 shows a method diagram for determining a vessel estimated time of arrival assessment in accordance with one or more embodiments.

FIG. 3 shows a method diagram for ingesting and processing data in accordance with one or more embodiments.

FIG. 4A shows a method diagram for model generation for determining vessel estimated time of arrival in accordance with one or more embodiments.

FIG. 4B shows a method diagram for predicting vessel estimated time of arrival in accordance with one or more embodiments.

FIG. 5 shows a device diagram of a server in accordance with one or more embodiments.

FIG. 6A shows a method diagram for determining a vessel estimated time of arrival in accordance with one or more embodiments.

FIG. 6B shows another method diagram for generating a vessel estimated time of arrival model in accordance with one or more embodiments.

FIG. 7 shows a map diagram for port boundary identification in accordance with one or more embodiments.

FIG. 8 shows another map diagram for port boundary extraction in accordance with one or more embodiments.

FIG. 9 shows another map diagram for geospatial joins in accordance with one or more embodiments.

FIG. 10 shows another map diagram for determining remaining time of travel in accordance with one or more embodiments.

FIG. 11 shows an example map diagram of a geospatial dataset join including wave height data in accordance with one or more embodiments.

FIG. 12 shows a dataset diagram in accordance with one or more embodiments.

FIG. 13 shows a model evaluation diagram in accordance with one or more embodiments.

FIG. 14 shows a user interface diagram in accordance with one or more embodiments.

FIG. 15 shows another user interface diagram in accordance with one or more embodiments.

FIG. 16 shows another user interface diagram in accordance with one or more embodiments.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, personal computer, laptop, personal data assistant, cellular telephone, smart-phone device, tablet computer, wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various embodiments have been described herein by way of example only. Various modifications and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

As recited herein, vessel tracking systems may include Automatic Identification Systems (AIS), and other such vessel tracking systems whether terrestrial-based or satellite-based.

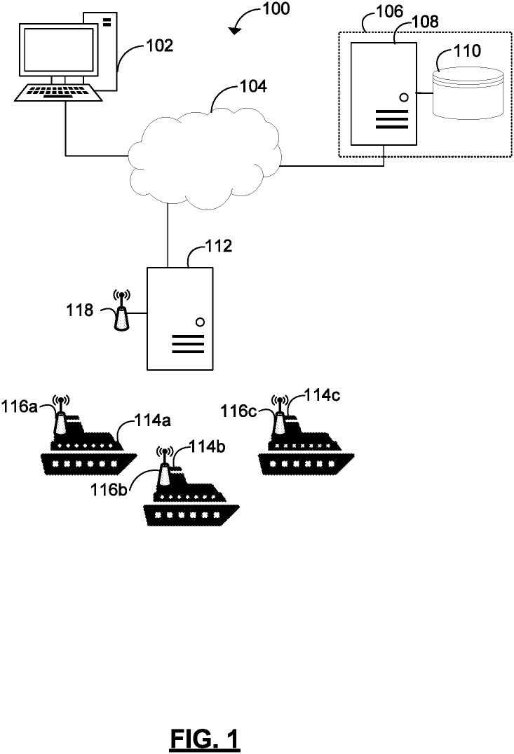

Reference is first made to FIG. 1, showing a system drawing 100 of a system for determining estimated time of arrival (ETA) for vessels. The system 100 has a user device 102, a network 104, an ETA service 106 having a server 108 and a database 110, at least one vessel tracking provider server 112 having a vessel tracking transceiver 118, and at least one vessel 114 having a vessel tracking transceiver 116.

The ETA service 106 may receive and store in database 110 a plurality of datasets. The datasets received and stored may be two types: geospatial datasets and alphanumeric datasets. The plurality of datasets can include (as noted above) vessel tracking data from vessel tracking transceiver 118. The vessel tracking data may be collected by satellites, ground stations, or from transceivers onboard vessels. This may include both real-time and historic data. The ETA service 106 may receive and store in database 110 one or more vessel characteristics datasets, e.g. from IHS Markit, a vessel owner, operator, or another source. The ETA service 106 may receive and store in database 110 one or more weather datasets, e.g. those obtained from weather service companies or open data providers, such as the Copernicus Climate Data Store (managed by the European Commission). The weather dataset may include historic, real-time, and forecast data.. The ETA service 106 may receive and store in database 110 one or more port datasets, e.g. those obtained from commercial data providers, port websites, simulation methods of port operations. The one or more port datasets may include those determined by data mining analytics from other datasets, such as data clustering over AIS data, or digitization over satellite images or other forms of maps. The one or more port datasets may include static data and data that changes over time. The ETA service 106 may receive and store in database 110 routing datasets, e.g. those obtained from commercial data providers or generated based on data mining of other datasets, such as AIS data. The ETA service 106 may receive and store in database 110 other geospatial datasets, e.g. those obtained from commercial data providers, open data providers, or generated based on data mining of other datasets, such as vessel tracking data or digitization of satellite images or other forms of maps. The ETA service 106 may receive and store in database 110 existing ETA datasets, e.g. obtained from vessel tracking data, port websites, shipping line agents, or other stakeholders in the maritime domain. These datasets may be used as baselines to provide comparison of the ETA values generated for vessels by ETA service 106.

The geospatial datasets received from geospatial dataset providers and stored by database 110 may include the weather datasets, the port datasets, the routing datasets, and other geospatial datasets. The alphanumeric datasets received from alphanumeric dataset providers and stored in the database 110 may include vessel characteristic datasets, shipping line datasets e.g. ETA datasets, or other vessel information.

User devices 102 may be used by an end-user to access an application (not shown) running on ETA service 106. For example, the application may be a web application, or a client/server application. The user devices 102 may be a desktop computer, mobile device or laptop computer. The user devices 102 may be in network communication with service 106 via network 104. The user devices 102 may display the application and may allow a user to request an ETA of at least one of the vessels 114. The end user may be from a government agency such as the Coast Guard, a port, a defense organization such as the Navy, a corporate organization such as an international shipping company, or another interested party.

Network 104 may be a communication network such as the Internet, a Wide-Area Network (WAN), a Local-Area Network (LAN), or another type of network. Network 104 may include a point-to-point connection, or another communications connection between two nodes.

ETA service 106 includes one or more servers 108 and one or more databases 110. ETA service 106 may provide software services to the user device 102 and may communicate with at least one vessel tracking provider server 112 to receive vessel tracking data. The service 106 may further communicate with other data providers (not shown), including 3^{rd} party data providers for vessel characteristic information, weather information, port data, routing data, other geospatial data, and other ETA data.

ETA service 106 may provide a web application that is accessible by the user devices 102. The web application may provide user authentication functionality as known, so that a user may create an account and/or log into the web application in order to request or receive ETA information for vessels. The ETA 106 may provide the vessel ETA functionality to a user as described herein.

ETA service 106 may implement an Application Programming Interface (API) to receive requests from the user devices 102, or from a third party (not shown). The ETA service 106 may reply to the API requests with API responses, and the API responses may provide the functionality of the web application provided by service 106. The API may receive requests and send responses in a variety of formats, such as JavaScript Object Notation (JSON) or eXtensible Markup Language (XML).

The ETA service API may receive requests from an application running on the user devices 102. The application running on the user devices 102 may be downloaded from the web application provided at service 106 or may be downloaded from the Google® Play Store or the Apple® App Store.

Server 108 is connected to network 104 and database 110 and may provide functionality as described herein. The server may implement one or more external APIs, as described above. The server 108 may be a physical server, may be the same server device as the device running the database 110, or may be provided by a cloud provider such as Amazon® Web Services (AWS).

Server 108 may have a web server provided thereon for providing web-based access to the software application providing the API and/or the software application providing the web application. The web server may be one such as Apache®, Microsoft® IIS®, etc. The software application providing the API and the web application may be Apache® Tomcat, Ruby on Rails, or another web application framework as known.

The database 110 is connected to network 104 and may store historical data for a number of vessels, including vessel tracking data, vessel characteristic data, weather data, port data, routing data, other geospatial data, and other ETA data.

The database 110 may further store historical vessel information for the datasets stored in database 110, or future predictions of datasets in database 110.

The database 110 may be a Structured Query Language (SQL) such as PostgreSQL or MySQL or a not only SQL (NoSQL) database such as MongoDB. For example, vessel profiles may include historical behavior change frequency distribution information as described herein.

Vessel tracking provider server 112 may be a first party server which is within the same organization as the server 106, for example, a shore-based or satellite-based AIS receiver. Alternatively, the vessel tracking provider server 112 may be a third-party provider, such as exactEarth®, ORBCOMM®, Spacequest®, or Spire®. The service 106 may receive vessel tracking data from multiple different vessel tracking provider servers 112.

The vessel tracking provider server 112 may have a vessel tracking transceiver 118 that receives vessel tracking transmissions of the at least one vessel 114. The vessel tracking transmissions may include a plurality of data as described herein about each vessel and its location. The vessel tracking provider may provide an API for the service 106 to request periodic vessel tracking transmission data to be transferred. The vessel tracking provider may alternatively push vessel tracking transmission data to an API at the service 106.

The vessel tracking provider server 112 may provide vessel tracking data in a plurality of formats and standards. In an exemplary embodiment, the vessel tracking provider server 112 may provide AIS data according to the International Maritime Organization (IMO) International Convention for the Safety of Life at Sea (SOLAS) treaty. The vessel tracking provider server 112 may perform pre-processing of vessel tracking data that is received by the vessel tracking transceiver 118.

As disclosed herein, vessel tracking data may allow ships and shore-based stations to view marine traffic in a geographical area. For example, the vessel tracking data may be displayed on a chartplotter. Alternatively, vessel tracking transceiver signals for a geographical area may be viewed via a computer using one of several computer applications such as ShipPlotter and Gnuais.

Vessel tracking transceiver 118 may demodulate the signal from a modified marine VHF radiotelephone tuned to the vessel tracking frequencies and convert into a digital format that the vessel tracking provider server 112 can read, store in memory, transmit over network 104, or display (not shown). The vessel tracking data received by vessel tracking transceiver 118 and vessel tracking provider server 112 may then be shared via network 104 using TCP or UDP protocols as are known.

The vessel tracking transceiver 118 may be limited to the collective range of the radio receivers used in the network as the vessel tracking provider system. In one embodiment, the vessel tracking provider system may have a network of shore-based vessel tracking transceivers to provide broader geographical coverage. In another embodiment, the vessel tracking provider system may have a network of satellite-based vessel tracking transceivers that may be used to receive vessel tracking transmissions from earth orbit.

Vessel tracking transceiver 118 may be a satellite receiver, or a dedicated VHF vessel tracking transceiver. The vessel tracking transceiver may receive AIS signals from local traffic for viewing on an AIS enabled chartplotter, or using an AIS compatible computer system. Port authorities or other shore-based facilities may be equipped with transceivers. Vessel tracking transceiver 118 may transmit in the Very High Frequency (VHF) range, with a transmission distance of about 10-20 nautical miles.

In the exemplary example of an AIS vessel tracking system, transceiver 118 may use the globally allocated Marine Band channels 87 and 88. AIS transceiver 118 may use the high side of the duplex from two VHF radio “channels” (87B) and (88B). For example, the AIS transceiver may use channel A 161.975 MHz (87B) and channel B 162.025 MHz (88B).

Vessel tracking transceiver 118 may provide information such as a vessel’s identity, vessel type, vessel position, vessel course, vessel speed, vessel navigational status and other vessel safety-related information automatically to appropriately equipped shore stations, other ships and aircraft. Vessel tracking transceiver 118 may receive automatically such information from similarly fitted ships, may monitor and track ships; and may exchange data with shore-based facilities.

At least one vessel 114 may carry an AIS transceiver according to SOLAS regulation V/19 - Carriage requirements for shipborne navigational systems and equipment. This regulation requires that AIS transceivers be fitted aboard all ships of 300 gross tonnage and upwards engaged on international voyages, cargo ships of 500 gross tonnage and upwards not engaged on international voyages and all passenger ships irrespective of size. The vessels 114 may be a variety of different types of vessels, including sailboats, shipping vessels, motorboats, yachts, passenger vessels, ferries, etc. There may be some vessels not required under SOLAS regulation who elect to fit AIS transceivers anyways.

Vessel tracking transceivers 116 aboard vessels 114 may function the same as vessel tracking transceiver 118, but may be designed for operation on a vessel (i.e. sizing, electrical power requirements, etc.). Further, each vessel 114 may transmit its location using its corresponding vessel tracking transceiver 116. This may allow vessels to provide their location to other vessels to ensure awareness and visibility of their vessel.

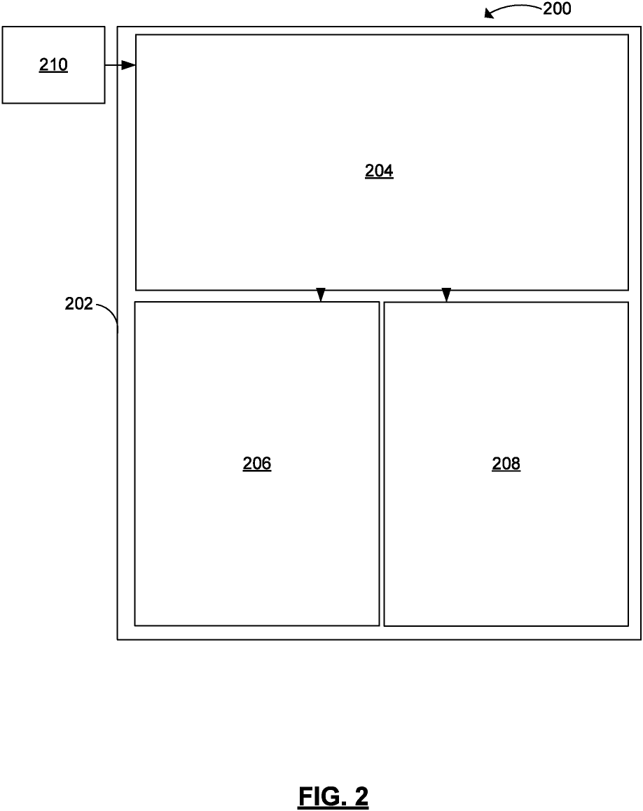

Referring next to FIG. 2, there is shown a method 200 for determining a vessel ETA in accordance with one or more embodiments. Method 200 may be a high-level method that is described in further detail herein. Method 200 may be performed by server 202, having data ingestion and processing 204, model generation 206, and enhanced ETA prediction 208.

One or more data sources 210 may be provided as input to the server 202. These one or more data sources may include geospatial datasets and alphanumeric dataset. These one or more data sources may include one or more vessel tracking data sources, one or more vessel characteristic data sources, one or more weather data sources, one or more port data sources, one or more routing data sources, other geospatial data, and other ETA data, etc.

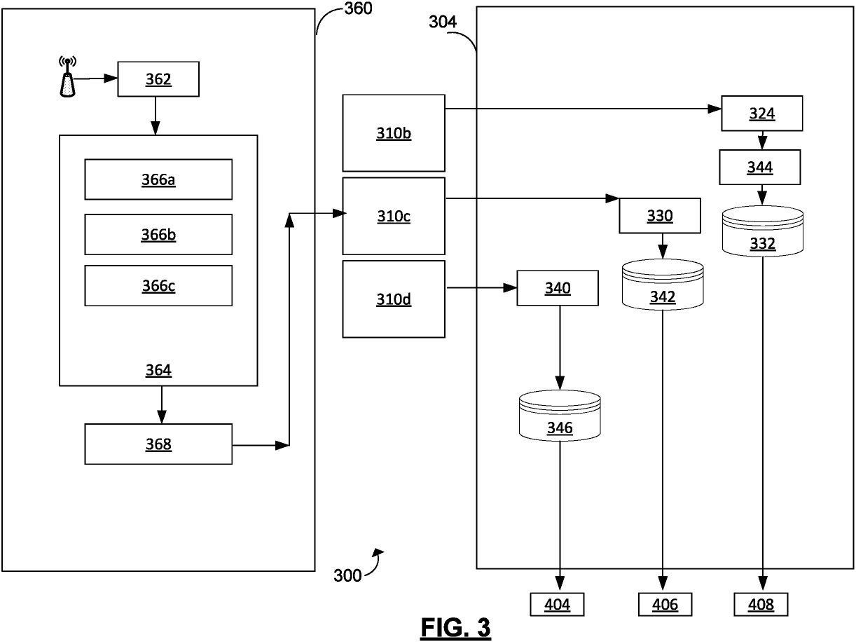

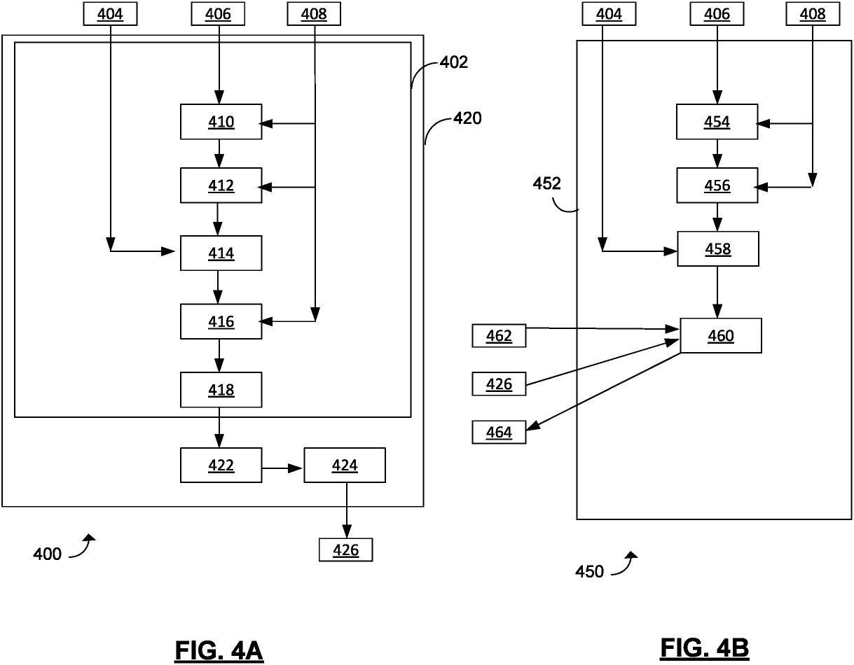

The data from the one or more data sources 210 is received and processed by a data ingestion and processing 204. The data processing is described in further detail in FIG. 3. The ingested data is received by model generation 206 (which is described in more detail in FIG. 4A) and enhanced ETA prediction 208 (which is described in more detail in FIG. 4B).

FIG. 3 shows a data processing method 300 provided by ETA server 304 in accordance with one or more embodiments. The data processing method may receive data from one or more data sources including one or more vessel geospatial dataset providers 310b, one or more vessel tracking data providers 310c, and one or more vessel alphanumeric dataset providers 310d. Data ingestion and processing may occur periodically, i.e. daily, weekly, monthly, or may occur generally in real-time.

The geospatial dataset providers 310b provides geospatial data (that is, geospatial data in addition to the vessel tracking dataset provided by the vessel tracking dataset provide 310c) such as weather datasets, the port datasets, the routing datasets, and other geospatial datasets. The geospatial dataset providers 310b provide geospatial datasets that may be received 324, processed 344, and stored in a geospatial database 332. The geospatial datasets may define a plurality of points, lines, shapes or polygons that may be superimposed on a map to define the geospatial boundaries.

The weather dataset provided may be obtained from weather service companies or open data providers, such as the Copernicus Climate Data Store (managed by the European Commission). The weather dataset can include historic, real-time, and forecast data. The fields associated with the weather dataset can include ocean currents speed and direction, wave height and direction, wind speed and direction, and sea surface temperature.

The port dataset provided may be obtained from commercial data providers, port websites, simulation methods of port operations, or by data mining other datasets, such as data clustering of vessel tracking data, or digitization over satellite images or other forms of maps. The port dataset can include static data and data that changes over time. The fields associated with the weather dataset can include port boundaries: including polygons with delimitation of terminals, berths, anchorage locations, canals, and other areas key for common port operations; port approach information and restricted areas, port congestion information, shipping line priority information, port access scheduling information, historic port delay information, other port specific key performance indicators (KPIs), e.g. on-time performance.

The routing dataset provided may be obtained from commercial data providers or by data mining other datasets, such as vessel location data. The fields associated with the routing dataset can include distance from current location to port of destination, typical route between origin and destination ports (by ship type), typical speed between origin and destination ports (by ship type), and most likely route considering weather and other conditions (e.g., traffic).

The other geospatial datasets may be obtained from commercial data providers, open data providers, or by data mining of other datasets, such as AIS data or digitization over satellite images or other forms of maps. Fields associated with these other geospatial datasets may include geospatial boundaries for: exclusive economic zones, environmentally protected areas, Emission Control Areas (ECAs), piracy areas, low speed areas, such as canals, port approaches, straits, and other areas under special maritime regulations.

The alphanumeric dataset providers 310d provide alphanumeric datasets that are ingested at alphanumeric data ingestion 340 and stored in alphanumeric database 346. The alphanumeric database 346 may be stored in the database 110 (see e.g. FIG. 1) and may include vessel characteristic datasets, shipping line datasets e.g. ETA datasets, or other vessel information. The alphanumeric datasets may include alphanumeric data associated with vessels, ports, or other maritime data.

The vessel characteristics dataset may include fields such as one or more of vessel identification numbers, vessel type (e.g., oil tanker, bulk carrier, container ship) information, vessel navigation capabilities (e.g., maximum speed), vessel dimensions (length, width, height, draught), vessel mechanical issues data, vessel engine type data, vessel fuel curves, vessel fuel type data, vessel tonnage data, etc. The vessel characteristics database may be, for example, one provided by IHS Markit, data from the vessel owner, operator, or another source.

The shipping line dataset may be obtained from vessel tracking data, port websites, shipping line agents, or other stakeholders in the maritime domain. These datasets may be used for a baseline to compare the present ETA system against conventional ETA systems.

The alphanumeric datasets may be, for example, the National Maritime Information Database (NMID) from the Canadian Government, the Information Handling Services (IHS) vessel database, the Spectrum Direct Database provided by Industry Canada/ITU. The alphanumeric datasets may include vessel name information, vessel crew information (including but not limited to, changes in vessel crew manifests, crew member nationality, etc.), general classification information, individual classification information (including classification history), gross tonnage, passenger capacity information, vessel length, vessel MMSI number, vessel registration information including applicant information of the vessel registration, vessel ownership information (for example, the corporation of legal entity e.g. Groenewald & Germishuys CC, Tangming Co Ltd), etc. The alphanumeric datasets, once processed by alphanumeric data ingestion 340, may be stored in vessel database 332. The vessel database 332 may be stored at database 110 (see FIG. 1). The vessel database 332 may provide vessel data 350 to the model generation (see FIG. 4A) and the ETA prediction (see FIG. 4B).

The vessel tracking dataset provider 310c provides vessel tracking data that may include: geographic coordinates (data such as longitude and latitude), vessel SOG (speed over ground), vessel COG (course over ground), vessel heading, a timestamp (in UTC time), vessel dimensions (length, width, height, draught), vessel self-reported ETA (which may not be an accurate estimate), vessel self-reported destination port (which could include terminal, and/or berth), etc.

Data ingestion and processing 300 may be performed to receive data into data lakes and may use a data streaming service such as Amazon® Web Services (AWS®) Firehose Kinesis®. Data may be ingested in near real-time or using a periodic polling process.

Geospatial data is received from the one or more geospatial data providers 310b at geospatial data ingestion 324. The geospatial data can include regional boundary data received from one or more region boundary data providers. The geospatial data ingestion 324 may involve pre-processing of the region boundary data. Region boundary data curation 344 may be performed automatically, or manually, in order to connect disparate region boundaries in the region boundary data. The region boundary data may include a plurality of connected points, where each point has latitude and longitude data. The points may further be connected using the geometric location of ports, marine regions, and locations of Exclusive Economic Zones (EEZ). The region boundaries may be encoded in a shapefile. A shapefile may be a simple, nontopological format for storing the geometric location and attribute information of geographic features. Geographic features in a shapefile may be represented by points, lines, or polygons (areas).

Marine regions and EEZs may be provided as shapefiles. The marine region and EEZ shapefiles may be, for example, those produced by Flander Marine Institute which maintains a database of international borders in open waters. At 344, the shapefiles may be altered or curated. For example, an EEZ may be altered further to improve data processing times by reducing the size of the shapefile. The curation 344 may be performed by generating a one-way buffer in land for the EEZ. This may simplify the geometry around the coastline and allow joining of vessel tracking messages that may be at the land-sea boundary. The buffering of only 1 side may prevent an increasing of the extent of a countries EEZ.

The port shapefiles may be determined using the World Port Index ports. The ports may be converted into points, and then buffered to generate port zone shapefiles.

At 344, one or more port boundaries datasets may be determined, for use in identifying the start port and end port of a vessel’s trip. Port boundaries may be represented as closed polygons. Once a vessel leaves a port polygon it may be assumed that it has departed from such port. Additionally, once a vessel enters a port polygon it may be assumed that it has arrived at that port. In some cases, a line may be used to mark the boundary of a port (for example, as a “finish line”), especially in situations where the port has narrow access, e.g. ports located in river mouths. In such cases the port may be enclosed in a closed polygon that ultimately connects the ends of such finish line.

Referring together to FIGS. 3 and 7 together, the boundary of a port may be represented by only one polygon or a group of close by polygons for ports with complex geographic layouts.

Referring to FIG. 7(a), a single port 702 may have a single port boundary 704 for one small port.

Referring to FIG. 7(b), two side-by-side ports 712a, 712b (or more generally, ports that are close to one another) may be grouped together by a single port boundary 714.

Referring to FIG. 7(c), a river-mouth port 722 with a line-based port boundary 724 is shown, i.e. a “finish line” boundary as described above.

Referring to FIG. 7(d), port boundaries may be represented at multiple hierarchical levels to include more granular details of port areas, with a large polygon enclosing ports and multiple smaller polygons within the port may represent terminals or berths. One port boundary may enclose several ports if they are close to each other and a geographic aggregation may simplify the analysis, facilitate the acquisition of training data, and/or yields more accurate predictive results.

Port boundaries such as those shown in FIGS. 7(a) - 7(d) may be obtained from existing maps or by digitization of satellite images, aerial photographs, or similar geospatial data. Existing maps may be in multiple formats such as raster (e.g., .tiff, .jpg) or vector (e.g., .shp, .kml, .cad) formats.

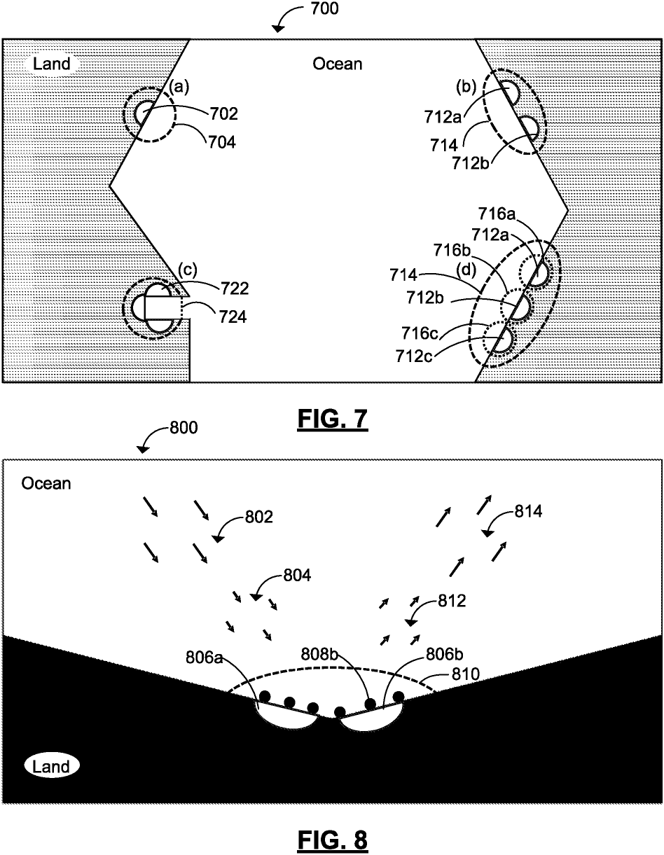

Referring to FIG. 8, port boundaries may be extracted by applying data mining analytics over other datasets, including vessel location data such as AIS data. Vessels transmit location messages (including AIS messages) even when they are stopped at berths. Since these messages include speed and navigation status (e.g., at anchor, moored, under way) historic vessel location data may be used by applying clustering methods such as DBSCAN to determine precise port boundaries.

For example, in FIG. 8, a port boundary 810 may be determined by analysing speed and direction of travel from historic vessel location data. As vessels approach the ports 806a and 806b, they may arrive at higher speeds, as reflected in the higher speed vessel location messages 802 (i.e., speed vectors for the vessel). As deceleration occurs, lower speed approach location messages 804 may signify their arrival near a port such ports 806a and 806b. While the vessel is docked at port 806b (for instance at berth 808b) or moored within port boundary 810, they may continue to send vessel location messages. As the vessel departs from the port 806, the departing vessel location messages may be slow 812 (i.e. speed vectors), and subsequently faster 814.

Referring back to FIG. 3, after the regional boundary data curation 344 is complete, the curated regional boundary data may be stored in geospatial database 332. The geospatial database 332 may be provided by database 110 (see FIG. 1)

Vessel 360 may be a vessel such as vessel 114 (see FIG. 1). The vessel 360 may have a vessel tracking transceiver 362 that receives vessel location data. There may be many vessels such as vessel 360, including hundreds, thousands, tens of thousands, or hundreds of thousands. The vessel 360 may receive vessel location (or vessel tracking data, as used interchangeably herein) and may incorporate vessel-based data including ship geographic location and vessel kinematic data at 364. This may include individual vessel location data 366 which may incorporate the kinematic data measured by vessel 360. The vessel kinematic data may describe a vessels motion in six degrees of freedom. This may include different frames of reference, for example, kinematic data in a North-east-down frame, kinematic data in a geometric frame, kinematic data in a body-fixed frame, or kinematic data in a hydrodynamic frame.

The vessel location data 366 may be transmitted by a navigational system 368 and transmitted to one or more vessel tracking providers 310c. Vessel tracking data is received from the one or more vessel tracking data providers 310c for vessel tracking data ingestion 330. This may include satellite-based or terrestrial-based tracking data.

In an exemplary embodiment, AIS data is received from the one or more AIS data providers 310c at AIS data ingestion 330. As described above, the AIS data may include Satellite AIS data (SAIS) and Terrestrial AIS data (TAIS). The AIS data may be stored as point data, corresponding to the periodic transmissions of an AIS equipped vessel.

Vessel tracking data may be processed by vessel tracking data ingestion 330 and may be decoded from a raw format. The processed vessel tracking data may be stored in the AIS database 342.

In an exemplary embodiment, AIS data may be processed by AIS data ingestion 330 and may be decoded from the AIS National Marine Electronics Association (NMEA) 0183 or NMEA 2000 data formats. The decoding may further include decoding AIS sentences such as AIVDM sentences. Decoding of AIS messages may further include decoding based on ITU Recommendation M.1371 (including revisions), IALA Technical Clarifications on Recommendation ITU-R M.1371-1, and IEC-PAS 61162-100. An AIVDM sentence may describe the vessel position and vessel information of a vessel, or other pieces of information as described in the AIS specifications. The processed AIS data may be stored in the AIS database 342.

The vessel tracking data ingestion 330 may determine variables from each vessel tracking data point of vessel tracking data for a vessel.

The vessel tracking data ingestion 330 may further match vessels identified in the vessel tracking data with vessels found in the vessel database 332 or vessel incident database 326.

The vessel tracking database 342 may be stored at database 110 (see FIG. 1).

The alphanumeric dataset in alphanumeric database 346, the vessel tracking dataset in vessel tracking database 342 and the geospatial dataset in geospatial database 332 are provided to the estimate time of arrival determination system (see FIGS. 4) at 404, 406, and 408 respectively.

Referring next to FIG. 4A, there is shown a method 400 for data preparation for training datasets for determining estimated time of arrival determination in accordance with one or more embodiments. The method 400 may run at a data preparator 402, and may receive the alphanumeric dataset in alphanumeric database 346, the vessel tracking dataset in vessel tracking database 342 and the geospatial dataset in geospatial database 332 at 404, 406, and 408 respectively.

At 410, a plurality of vessel trips may be determined from the vessel tracking data 406. This can include identifying a vessel trip between an origin port and a destination port. While port is indicated here, it is understood that a vessel trip could be between another origin point, including a mooring point, a repair facility, a shipyard, an anchorage, etc. To identify the plurality of vessel trips, the port boundaries of the geospatial data 408 may be used to identify an origin and a destination of the vessel trip in the vessel location data 406.

A trip is a unique voyage between an origin and destination ports by a specific vessel. If a vessel travels between an origin and destination ports more than once, multiple individual trips may be identified. One trip may be represented geographically by a line connecting checkpoints followed by the vessel when traveling between the origin and destination ports. Such checkpoints may be given by geographic coordinates included in vessel tracking messages transmitted by the vessel along its voyage. Depending on the vessel and the configuration of the vessel tracking transmitter, a vessel could transmit vessel tracking messages at a frequency ranging from multiple messages per minute to a few messages per hour or even fewer. While AIS tracking messages have been given as examples of vessel location messages of a vessel along a trip, the proposed enhanced ETA system may equally apply to any geo-positioning or tracking technology used that identifies the geographic location of a vessel along a trip, or a segment of a trip. Examples of other such geo-positioning technologies include but are not limited to coastal RADAR, radio frequency (RF) signals, satellite images, Internet of Things (IoT) transmitters, emergency position-indicating radio beacons (EPIRBs), or vessel traffic services (VTS).

At 412 and 414, join operators may be used to combine the vessel location messages with data from the geospatial dataset and the alphanumeric dataset respectively. For each vessel location message along the trip, the values of the input variables at that instant may be retrieved and used to in a left join between the vessel location data point (left in join) and the other variables. Input variables might come from a variety of sources, including the fields of the geospatial data and the alphanumeric data. Access to those data sources may be accomplished through multiple communication channels, including but not limited to database socket connections (for example, to the database 110 in FIG. 1), API calls, local storage devices, real-time sensors, and cloud computing storage services.

At 412, a spatial join operation may be performed between the vessel location data 406 in the plurality of vessel trips and the geospatial data 408 to associate data from a source variable to a target variable when the two observations fulfill a condition based on the geographic relationships between them. For instance, an observation of ocean wave height may be joined to a vessel location message if such an observation is within a particular distance (for example, a 2 km radius) of the vessel message. The particular distance, the 2 km radius, is the condition in this case that is required as a pre-condition for join to be performed. If no value of wave height is available within that radius the join is not performed.

Referring to FIG. 9, there is shown an example map diagram 900 of a vessel transmitting location messages through a geospatial area defining an Emission Control Area (ECA). The join may have one or more input variables from the geospatial dataset attached to the vessel location messages by virtue of the vessels proximity to the ECA. The joined input variables may include: a regulatory constraint, which may be joined with the vessel locations messages transmitted by the vessel when navigating inside the ECA.

A vessel begins a trip at the origin port 902 with an intended destination of destination port 912, and travels through the ocean between the origin and the destination. Meanwhile the vessel tracking transceiver transmits vessel location (or vessel tracking) messages periodically through the voyage.

Vessel tracking messages i 904 and j 906 may be for vessel location messages in the ocean and outside of the ECA, therefore lacking the precondition for the geospatial join of the ECA geospatial data.

As the vessel enters the ECA 910, vessel tracking message k 908 is transmitted. Since this vessel tracking message is inside the geospatial boundary of the ECA, the precondition of the geospatial join is met and the ECA geospatial data is joined with vessel tracking message k 908.

In the example in FIG. 9, the ECA data may be part of a geospatial dataset received and stored in the database. The ECA data may define one or more geospatial bounding boxes that identify a geospatial area associated with the ECA.

A spatial join operations such as the one described in open-source library GDAL may be used to execute these operations systematically over datasets with thousands or millions of data points.

The boundaries defined in the geospatial datasets (e.g. port boundaries) may be geometric boundaries. The boundaries may be stored in a shapefile (i.e. nontopological format for storing geometric location and attribute information of geographic features).

Shapefiles may be received from various geospatial datasets including port boundaries, marine regions, Emission Control Areas (ECAs) and Exclusive Economic Zones (EEZs). Geographic features in a shapefile can be represented by points, lines, or polygons (areas).

A one-way buffer may be used to simplify the geometry around a coastline as well as allowing joining of vessel tracking messages that may be on the land boundary.

Referring back to FIG. 4A, at 414 an alphanumeric join may be performed to the resulting dataset from the geospatial join at 412.

An alphanumeric join is an operation to attach data from a source variable to a target variable when the two observations fulfill a condition based on the matching of an alphanumeric value. Moreover, the operation of joining variables on a matching alphanumeric value may be flexible to allow for non-exact matching when only a few differences between source and target variables arise, like lowercase versus uppercase letters, space-separated versus hyphen-separated words, etc. Another technique for matching can involve pattern matching using regular expressions. Alphanumeric join operations may function similar to alphanumeric joins available in relational databases, including matching criteria, data merging strategy (e.g., left join, inner join), and efficient data scanning methods.

For example, alphanumeric information relating to a vessel engine type may be joined with a vessel location message if both data records correspond to the same vessel identifier (generally the MMSI number). Another encoding systems for unique identification of vessels may include the International Maritime Organization (IMO) number, the U.S. Vessel Identification Numbers (VIN), or the European Number of Identification or European Vessel Identification Number (ENI). These may be provided by the alphanumeric dataset providers (see e.g. 310d in FIG. 3) of vessel-specific alphanumeric information that are maintained by governments, international organizations, and private companies.

At 416, the resulting dataset from the alphanumeric join is used to generate a remaining time of travel.

First, the determination of actual time of arrival (ATA) may be performed for the trips identified in the dataset. The ATA is the timestamp at which a vessel crosses a port boundary to enter a port. The trips in the dataset each have one ATA that marks the moment when the trip ends at the port of destination (i.e., by crossing the relevant port boundary). An ATA is a unique point in time that may be expressed as a timestamp that includes year, month, day, hour, minutes, and seconds, usually encoded in Coordinated Universal Time UTC. Other time encodings may be used as are known.

In order to identify exactly when a vessel crosses a boundary, the ATA of each trip may be obtained by a spatial analysis between vessel location data (such as AIS data) and port boundaries. More specifically, given a port boundary and multiple vessel location messages corresponding to one trip, spatial selection may be used to find the messages inside and outside of the boundary. These messages on the edges of the boundary may be organized by their timestamp and the last message transmitted when the vessel was outside may be selected, and the first message transmitted when the vessel was inside the port boundary may be selected. Finally, to determine the ATA from the first message inside and the last message outside, a weighted interpolation of the timestamps of those two vessel location messages may be applied in order to determine the ATA.

The goal of the ATA determination for the ETA system is to determine the arrival time of vessels traveling to specific ports. An arrival time may be expressed as a timestamp indicative of the instant when a vessel enters the boundary of the port of destination. Since timestamps are unique values, they are not often helpful output variables for use in training datasets for predictive models. Instead, the remaining time of travel (RTT) may be used as an output variable for the training dataset. Once a trip has started, RTT may be the period of time determined to be between a particular vessel message timestamp and the moment when the vessel arrives at its destination (ATA). RTT may be expressed in time interval units (e.g., days, hours, minutes).

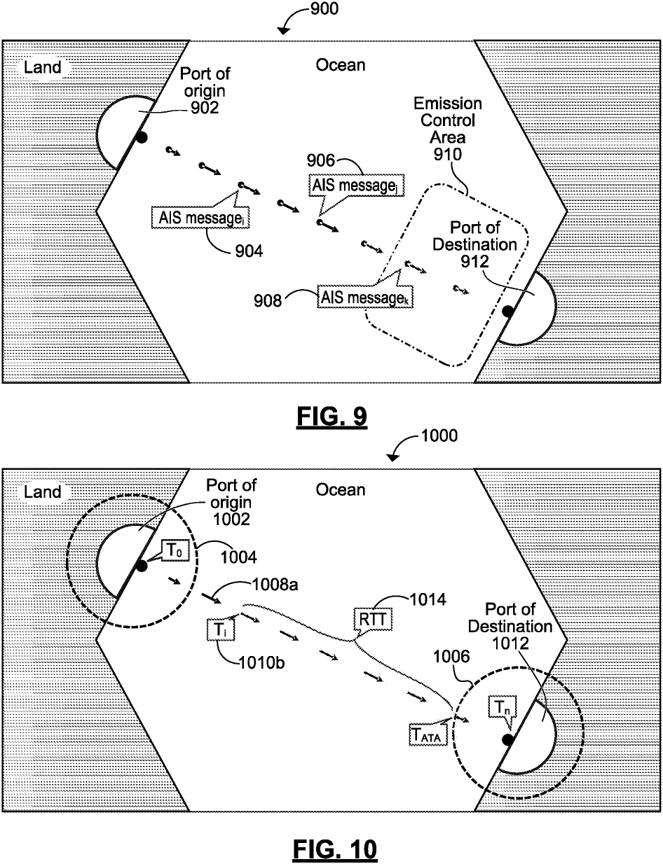

Referring to FIG. 10 there is shown a map diagram 1000 for a vessel travelling on a trip between a port of origin 1002 and destination port 1012. The port of origin 1002 has an origin port boundary 1004, and the destination port 1012 has destination port boundary 1006. Vectors 1008 are shown representing the direction and speed reported by the vessel through vessel location messages. While one vessel location message 1010b is shown, it is understood that each vector 1008 shown represents an individual vessel location message 1010 transmitted by the vessel.

In one example, an RTT 1014 may be determined for the vessel based on vessel location message 1010b, and shown between the location of the vessel in vessel location message 1010b at time Ti and time T_{ATA}. RTT 1014 may be extracted from vessel location data in three steps. First, historic vessel tracking data transmitted by vessels navigating to the specific port 1012, i.e., vessel location data of trips to that destination port 1012 is obtained. Second, the ATA of each trip to the destination port 1012 may be determined. Third, the RTT for each vessel location message in each trip is determined by calculating the difference between T_{ATA} and each vessel location message Ti along the trip. Finally, RTT is appended to each vessel location message along the trip and RTT becomes the output variable used to train the Machine Learning models.

At 418, feature engineering may be performed on the dataset generated by the RTT determination 416.

Feature engineering is a process that may make additional changes, additions, or subtractions from the received dataset to increase its value for further use as training data in Machine Learning methods. Feature engineering may involve the application of multiple techniques aimed primarily at reducing spurious datapoints, filling missing data points, and selecting the features that may show the strongest correlation with the output variable.

The join processes (geospatial join 412 and alphanumeric join 414) may assume that the geospatial and alphanumeric datasets have a consistent temporal and spatial resolution. In application however, real-world datasets may have a variety of resolutions, along with other data quality issues. To address this, feature engineering 418 may be performed. While shown after the geospatial join 412 and the alphanumeric join 414, feature engineering may optionally be performed before and after these joins.

The dataset received at feature engineering 418 based on the join processes (geospatial join 412 and alphanumeric join 414) may be a plurality of rows joined with geospatial and alphanumeric data.

Several feature engineering aspects that may be used before or after the geospatial join 412 and the alphanumeric join 416 are further described below. Exploratory data analysis

The feature engineering 418 may include performing a data analysis to determine summary statistics of rows in the dataset. Common statistics include but are not limited to percentage of missing values, total value count, mean, median, mode, standard deviation, variance, inter-quartile range, skewness, kurtosis, etc. Some statistics apply only to specific types of variables in a row (e.g., categorical, numeric). Summary statistics could also include descriptive charts such as histograms and scatterplots. Moreover, a key summary statistic may indicate the correlation, either linear or non-linear, between the input and output variables. The summary statistics may be presented as output to a user of the ETA system. Handling missing values

The feature engineering 418 may address missing values in the dataset.

For rows in the received dataset, missing values associated with each row may be inspected before and after the joins (e.g., geospatial join 412, and alphanumeric join 414). A row may be removed from the analysis based on a threshold of non-null data points, i.e. if a minimum percentage is not reached. Such a threshold may depend on the type of row in the dataset and the results of the exploratory data analysis (above). For the rows of the dataset that do meet the threshold one or more data imputation methods may be applied to fill-in the missing values associated with the row. Some data imputation methods include but are not limited to assigning the mean, median, or mode statistics.

### Handling Outlier Values

Variables in the received dataset may be inspected for outlier values before and after the joins. A variable in a row of the dataset may be removed entirely from the analysis if too many outlier or spurious data points are present in the row. A threshold in this case may depend on the type of variable and the results of the exploratory data analysis (above). Further methods may be applied to identify and filter outlier rows/data points, including but not limited to, distance from the mean value, statistical distance (e.g., Bhattacharyya distance), interquartile range, z-score analysis, and clustering. The outlier detection methods may be applied at a single variable in a row, or to multiple variables simultaneously in a row e.g., multivariate statistics.

### Handling Differences in Spatial and Temporal Resolution

Due to the large number of variables involved in the ETA system, as previously described, it is common to observe significant differences in spatial and temporal resolution of the geospatial and alphanumeric datasets (received in geospatial data ingestion 324 and alphanumeric data ingestion 340 respectively, and joined with the vessel location data 406 at geospatial join 412 and alphanumeric join 414). Such disparities may be reconciliated by tracking the observations and datasets that bring the highest resolution (or level of detail) and copying or interpolating the values from datasets with coarse resolutions to match the former.

Spatial resolution refers to the geographic extent of an observation. For example, the coordinates included in a vessel tracking message that may be representative of the location of a vessel within a radius of about 10 meters. A wave height dataset on the other hand, may be formatted as a grid with each cell corresponding to the conditions of the ocean in an area of several square kilometers.

Referring to FIG. 11, there is shown a map diagram 1100 showing an example resulting data after the spatial join 412 of vessel location data for a trip in a vessel location dataset, and wave-height data from a wave height dataset. The vessel trip in diagram 1100 is for a vessel between origin port 1102 and destination port 1104. The vessel trip includes a plurality of vessel location messages 1106 between the origin port 1102 and the destination port 1104, including vessel location messages 1106a, 1106b, 1106c, and 1106d. The joined geospatial dataset for wave height is also shown in cells 1108, where the value of one cell 1108 reflects the wave height in the wave height dataset. In the spatial join, the wave height of a cell 1108 may be assigned to vessel tracking messages determined to be within that cell 1108. Other heuristics may be used to determine the value joined with the respective vessel location message located in the cell 1108, including but not limited to a weighted interpolation between values of adjacent cells, or similar methods.

For example, in map diagram 1100, subsequent vessel location messages 1106a, 1106b, 1106c and 1106d are transmitted from a vessel on a trip and shown. In the spatial join, location message 1106a and 1106b may be assigned the wave height value in cell 1108a (i.e. assigned a wave height of 0.5 m). The location message 1106c may be assigned the wave height value in cell 1108b (i.e. assigned a wave height of 0.7 m). The location message 1106d may be assigned the wave height in cell 1108d (i.e. assigned a wave height of 1.2 m).

Referring back to FIG. 4A, the feature engineering 418 (as explained in the example in FIG. 11) may include determining a training dataset with a spatial resolution matching the dataset with the highest level of detail. Temporal resolution refers to the frequency at which a variable is observed. Due to the dynamic or relatively stable characteristics of some variables, there may be discrepancies between their temporal resolution. In these cases, the same approach may be followed (as described above) for the spatial resolution, where the dataset with the highest resolution is used to determine the training dataset, and values may be assigned to the values of the observation values of the coarser dataset.

In a preferred embodiment, the dataset with the highest number of observations (and highest resolution) in a time period is the vessel location dataset, with other datasets showing more temporal sparsity in their observations.

### Data Reduction and Augmentation

The feature engineering 418 may include data reduction of the training dataset. Data reduction is a process to reduce the number of observations in a dataset according to specific criteria. This may be performed to reduce the number of observations, and to improve the efficiency of further processing steps. For example, some variables do not change significantly over space or time; and therefore, using only a subset of the original observations in those variables may still preserve the underlying patterns and prevent unnecessary repetition. The criteria to determine when and how to run data reduction depends on the variables and their original spatial and temporal resolutions. In the proposed system a data reduction process is often run over the AIS stream since it is commonly the dataset with the highest number of observations.

Data augmentation is a process to increase the number of observations in a dataset according to specific criteria. This may be performed in order to increase the resolution in the observations of a dataset. In the context of the proposed system, data augmentation may be run when a trip shows significantly fewer vessel location messages than usual, leading to spatial and/or temporal sparsity. Data augmentation may be accomplished by multiple techniques including but not limited to interpolation and imputation.

When needed, we generally run the data reduction and data augmentation processes on the vessel location message stream before the spatial and alphanumeric joins at 412 and 414 respectively in order to improve computational efficiency in downstream steps.

### Feature Scaling

Feature scaling may be applied to numeric values in the received dataset, or the geospatial datasets at feature engineering 418.

Feature scaling is a process where numeric variables are transformed from their original range of values into a target range. Common scaling techniques include but are not limited to z-score and min-max. Z-score transforms the original values into a Gaussian distribution with mean equals zero and a standard deviation equal to one. Min-max scaling transforms the original values into a new range such that the previous minimum and maximum values coincide with the lower and upper limits of a predefined interval, usually [0, 1].

### Encoding for Categorical Variables

Encoding may be performed at feature engineering 418.

Encoding is a process to transform the observations of a categorical variable into numerical variables. One technique for that purpose is one-hot encoding, where a new numeric variable is created for each unique value in the original categorical variable, each new numeric variable holds a value of one for recordings with occurrences of the specific categorical value or zero otherwise. Encoding methods used in the proposed ETA system may include, but are not limited to one-hot encoding.

### Correlation Analysis

Correlation analysis may be performed at feature engineering 418.

Correlation analysis is a process to quantify statistically the relationship between two or more numerical variables. This may be performed in order to identify input variables that show the strongest relationship with the target variable of the predictive task. In the proposed ETA system the target variable may be a remaining time of travel (RTT). Correlation analysis may be performed between the input variables and RTT in the training dataset. The outcome may be a ranking that identifies the most relevant input variables for downstream processing in the Machine Learning models.

At 420, a machine learning model may be generated based on the received training dataset from data preparation 402.

Machine learning may follow a series of steps that form a consistent and automated workflow. The proposed ETA system may be used to accurately predict the arrival time of a vessel at a destination port. In order to do so, historical datasets may be used to generate a model for making such a prediction. Instead of predicting an estimated time of arrival (ETA) directly, the proposed ETA system may predict the remaining time of travel (RTT) for a vessel.

Once the data preparation 402 is performed, a candidate dataset with input and output variables is provided. The candidate dataset received by model generation 420 may be split into three sets, training, validation and test.

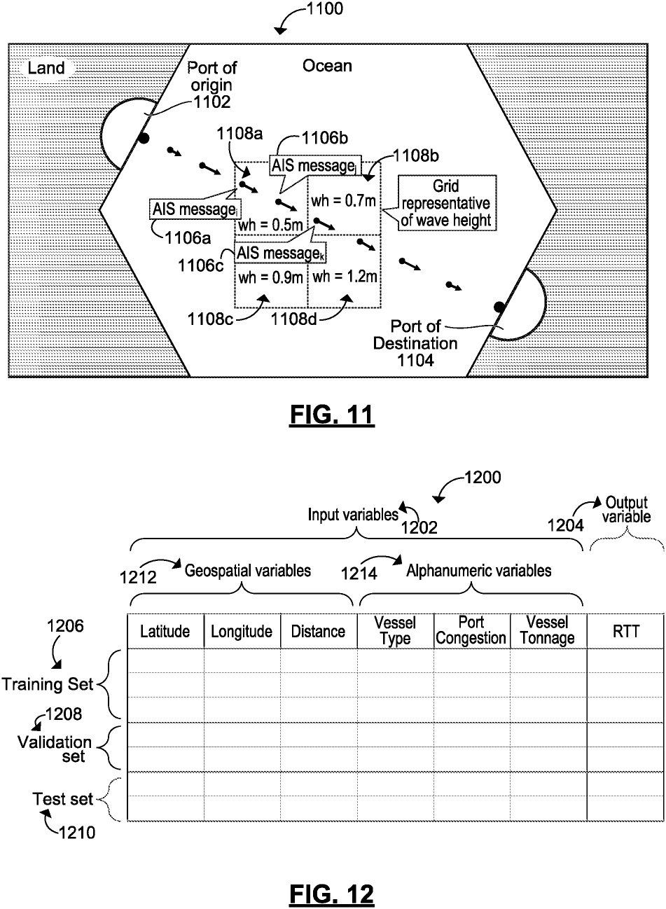

Referring to FIG. 12, there is shown a dataset diagram 1200 showing the structure of the resulting dataset from data preparation 402. In the dataset 1200 input columns 1202 are shown representing examples of some of the input variables and an output column 1204 is shown representing the output variable RTT. The input columns 1202 may include one or more geospatial variables 1212 joined from the one or more geospatial datasets described herein. For the purposes of the dataset diagram 1200, the vessel location message information may be considered and shown as geospatial variables, in addition to other geospatial variables from other datasets. The input columns 1202 may include one or more alphanumeric variables 1214 joined from the one or more alphanumeric datasets.

Rows representing vessel location messages are shown, split into training data 1206, validation data 1208, and test data 1210. The rows in the training data 1206 split may be used for training machine learning models, rows in the validation data 1208 may be utilized to find optimal hyperparameters for the models, and the test data 1210 may be used to evaluate the overall performance of the models as an indication of their effectiveness over unseen data. The percentages of data records in each split are often 70%, 15%, and 15% for the train 1206, valuation 1208, and test 1210 sets respectively. However, different percentages may also be used.

Data records corresponding to one vessel trip may only be present in one of the three splits (train 1206, validation 1208, test 1210). To do so, a unique identifier for each trip may be generated during the data preparation stage 402 to ensure such a condition is met. The condition may be used to prevent an issue commonly called “data leakage” that occurs when the same or very similar observations are utilized for training and evaluating a model.

### Model Architectures

Referring back to FIG. 4A, at 422 one or more machine learning models may be generated.

The architecture of a Machine Learning model determines how it makes use of available data to learn useful patterns and automate a task. Supervised Learning is a subarea of Machine Learning where the data includes examples of input and output variables, and the goal is to train a model that learns such mapping between inputs and outputs.

In a preferred embodiment, Supervised Learning may be used to train one or more models using the data described in FIG. 12, and elsewhere herein.

In Supervised Learning two groups of models may be used, some designed to automate classification tasks and others designed to automate a regression task. A classification model may take input variables and outputs a class from a predefined set of classes. For instance, a model that classifies between fraudulent or legitimate transactions based on characteristics of the transaction. A regression model may take input variables too but outputs a real number. In this context a real number is a value in a continuous one-dimensional interval. An example of a regression model is one that predicts body weight based on someone’s height.

In a preferred embodiment, one or more regression models may be used to predict RTT based on the provided input variables (see e.g. FIG. 12).

In an alternate embodiment, one or more classification models may be used to split the interval of the output variable into bins and assign such bins to classes.

The type of Machine Learning models used may include but are not limited to one or more of: Lasso Regression, Ridge Regression, Logistic Regression, Random Forest, Decision Tree Regression, Gradient-Boosted Trees, Linear Regression, Bayesian Linear Regression, Polynomial Regression, Robust Regression RANSAC, Ordinary Least Squares Regression, K-Nearest Neighbor Regression, Support Vector Regression, Gaussian Process Regression, Multilayer Perceptron, Artificial Neural Network, Deep Neural Network, Convolutional Neural Network, Recurrent Neural Network, and Long Short-Term Memory Network. A combination of one or more of these listed models may be used together.

### Model Training

At 422, one or more models may be trained based on the dataset (see e.g. FIG. 12).

As described herein, a number of possible Machine Learning models may be used, and without loss of generality a training process is described that functions at a high level. Specific details of the training process for each Machine Learning model may also be involved dependent on circumstances, including but not limited to software implementation, runtime optimizations, computing resources (e.g., memory), evaluation metrics, and hyperparameter optimization.

The training process 422 may operate over the training split of the data (see e.g. 1206 in FIG. 12), which may be about 70% of the available data. The training 422 may begin with a definition of an error metric, often called a loss function. Examples of error functions include but are not limited to Mean Absolute Error, Mean Squared Error, Root Mean Square Error, and Median Absolute Deviation. The choice of an error function may depend on several factors, including the specific requirements of the end user of the proposed system. The training 422 may progressively process examples of inputs and outputs from the training data, the number of examples it sees in an iteration may be referred to as batch size. Various optimization strategies may be used to progressively explore the potential combinations of model parameters. In other words, the optimization strategies may ensure that the value of the error function diminishes over time. Common optimization strategies may include but are not limited to gradient descent, stochastic gradient descent, brute-force search, simulated annealing, genetic algorithms.

### Evaluation

At 424, the evaluation process in the proposed system may occur simultaneously with the training 422. Like the training process 422, validation may be described at a high level due to the specific variations caused by the evaluation of multiple types of Machine Learning models. The validation split (see e.g. 1208 in FIG. 12) may be used to quantify the proximity of predicted values to ground truth samples.

At 424, the model generation 420 may automatically train and evaluate multiple models, and select the one with the lowest error when its predictions are compared to the validation split. Such process may be repeated periodically to avoid model drift or as needed.

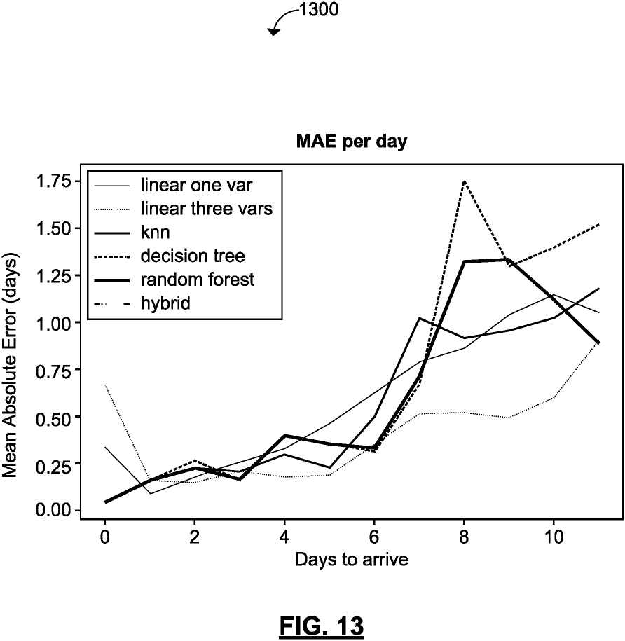

At 424, the evaluation may generated an evaluation diagram. An example of an evaluation diagram 1300 is shown in FIG. 13. This evaluation diagram 1300 shows the Mean Absolute Error (in days) for a plurality of different ML types based on the number of days away from arrival a vessel is. This diagram 1300 may be for a plurality of types of Machine Learning models as shown.

At 424 one or more models 426 may be selected from the set evaluated and may be provided to an ETA prediction system 452 (see FIG. 4B).

Referring next to FIG. 4B, there is shown a method 450 for determining estimated time of arrival determination in accordance with one or more embodiments.

A Machine Learning model generated based on FIG. 4A may be used at ETA prediction 452 to predict the RTT of one or more vessels.

At 454, vessel location data 406 including generally real-time location data is received by the ETA prediction system 450. This location data may describe generally in real-time the movement of one or more vessels as measured and received by one or more vessel location providers.

At 454, a plurality of underway vessel trips may be determined from the vessel tracking data 406. This may be performed as described at 410 in FIG. 4A, with the caveat that the trip may begin at an origin port and may not have arrived at the destination port. The vessel trip determination at 454 may further identify to future destination port based on the vessel tracking data 406 for the vessel trip (i.e. as reported by the vessel underway) or based on another geospatial or alphanumeric dataset. While port is indicated here, it is understood that a vessel trip originate at a mooring point, a repair facility, a shipyard, an anchorage, etc. To identify the plurality of vessel trips, the port boundaries of the geospatial data 408 may be used to identify all vessel trips that have begun (i.e. departed an origin port), and are underway. The vessel trips in vessel location data 406 may be from a plurality of origin ports to a plurality of future destination ports.

At 456, as described at 412 in FIG. 4A a geospatial join may be performed for each of the vessel trips underway.

At 458, as described at 414 in FIG. 4A an alphanumeric join may be performed for each of the vessel trips underway.

At 460, RTT predictions are made for the vessels identified in the plurality of vessel trips. The RTT prediction may be used to approximate the ETA of the vessels at their indicated destination port. The RTT prediction are made using the dataset received from the geospatial join 456 and the alphanumeric join 458 and the Machine Learning model 426 generated by model generation 420.

RTT predictions may be made periodically at 460 for all vessels on trips underway as identified. The RTT predictions may be grouped together by destination port, and may be transmitted by a network device to a port software system.

RTT predictions may be made based on an ETA request 462 received from a network device. The ETA request 462 may be an API request. The ETA request 462 may identify one or more vessels for the ETA prediction 460, and the ETA response 464 transmitted in response to the ETA request 462 may include the ETA predictions for the one or more vessels in the request. The ETA request 462 may identify one or more destination ports for the ETA prediction 460, and the ETA response 464 transmitted in response to the request may include the ETA predictions for the vessels having the one or more destination ports identified as the vessel’s destination.

The RTT may be used to predict time of arrival of a vessel at one or more arbitrary locations in the open ocean or ocean-feeding lake or river in sequence.

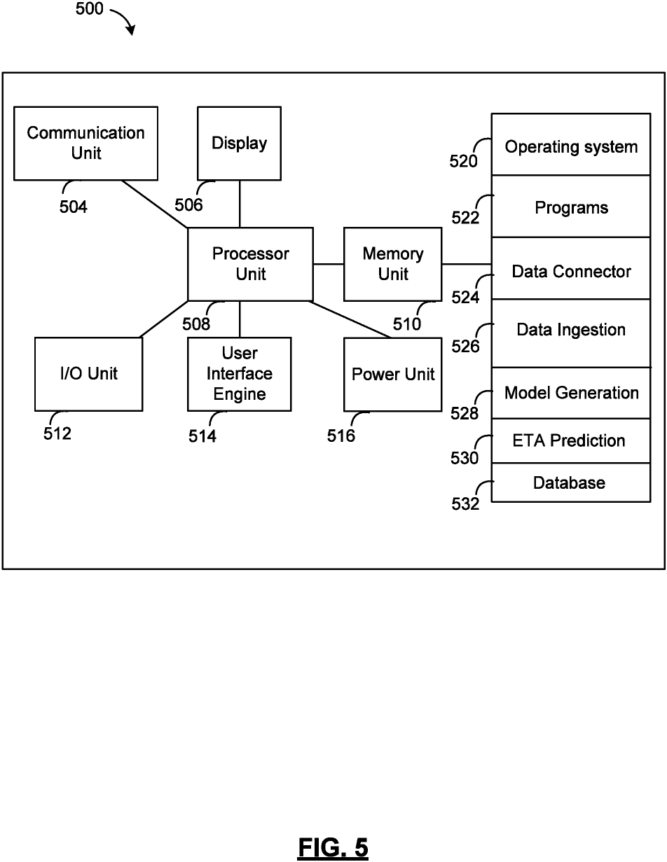

Referring next to FIG. 5, a device 500 of a server is shown in accordance with one or more embodiments. The server 500 may be the server 108 of remote server 106 (see FIG. 1).

The server 500 has communication unit 504, display 506, I/O unit 512, processor unit 508, memory unit 510, user interface engine 514, and power unit 516. The memory unit 510 has operating system 520, programs 522, data connector 524, data ingestion engine 526, model generation 528, ETA prediction 530 and database 532. The processing server 500 may be a virtual server on a shared host or may itself be a physical server.

The communication unit 504 may be a standard network adapter such as an Ethernet or 802.11x adapter. The processor unit 508 may include a standard processor, such as the Intel Xeon processor, for example. Alternatively, there may be a plurality of processors that are used by the processor unit 508 and may function in parallel. Alternatively, there may be a plurality of processors including a Central Processing Unit (CPU) and a Graphics Processing Unit (GPU). The GPU may be, for example, from the GeForce® family of GPUs from Nvidia®, or the Radeon® family of GPUs from AMD®. There may be a plurality of CPUs and a plurality of GPUs.

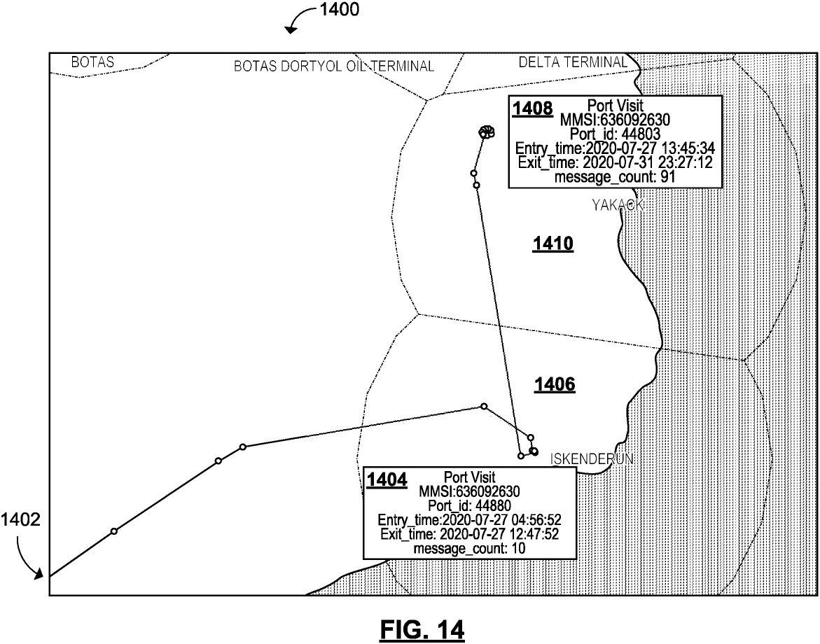

The processor unit 508 can also execute a user interface engine 514 that is used to generate various GUIs, some examples of which are shown and described herein, such as in FIGS. 14, 15, 16, 17 and 18. The user interface engine 514 provides for vessel ETA layouts for users to configure, request, review, and respond to ETA predictions, and the information submitted using these interfaces may be processed by the data ingestion engine 526, model generation 528, ETA prediction 530 and database 532. User interface engine 514 may be provided as an Application Programming Interface (API) or a Web-based application that is accessible via the communication unit 504.

I/O unit 512 provides access to server devices including disks and peripherals. The I/O hardware provides local storage access to the programs running on processing server 500.

The power unit 516 provides power to the processing server 500.

Memory unit 510 may have an operating system 520, programs 522, data connector 524, data ingestion engine 526, model generation 528, ETA prediction 530 and database 532.

The operating system 520 may be a Microsoft Windows Server® operating system, or a Linux-based operating system, or another operating system.

The programs 522 comprise program code that, when executed, configures the processor unit 508 to operate in a particular manner to implement various functions and tools for the processing server 500.

Data connector 524 may provide for integration, either push or pull with one or more vessel tracking provider servers, one or more geospatial providers, and one or more alphanumeric providers as described herein. The integration may be an API integration as known, for example using an XML based REST API. The data connector 524 may transmit and receive requests and responses to the one or more vessel tracking provider servers, the one or more geospatial providers, and one or more alphanumeric providers using the communication unit 504.

Data ingestion engine 526 may receive data from the data connector 524, and may ingest and pre-process data from the one or more vessel tracking providers, the one or more geospatial providers, and the one or more alphanumeric providers servers, as described in FIG. 3. The ingested data may be stored in database 532 and processed by vessel data processor 528.

Model generation 528 may receive data from the data ingestion engine 526 and from the database 532, and may generate one or more machine learning models as described at 420 (see FIG. 4A). Model generation 528 may send the generated one or more models to the ETA prediction 530, and/or may store them in the database 532.

ETA prediction 530 may receive data from the data ingestion engine 526 and from the database 532 and may generate one or more ETA predictions as described at 452 (see FIG. 4B). ETA prediction 530 may store the one or more vessel ETA predictions in the database 532.

Optionally, database 532 may be hosted by server 500. The database may correspond to the database 110 (see FIG. 1). In an alternate embodiment, the database may run on a separate server from the server 500 and may be available via communication unit 504.

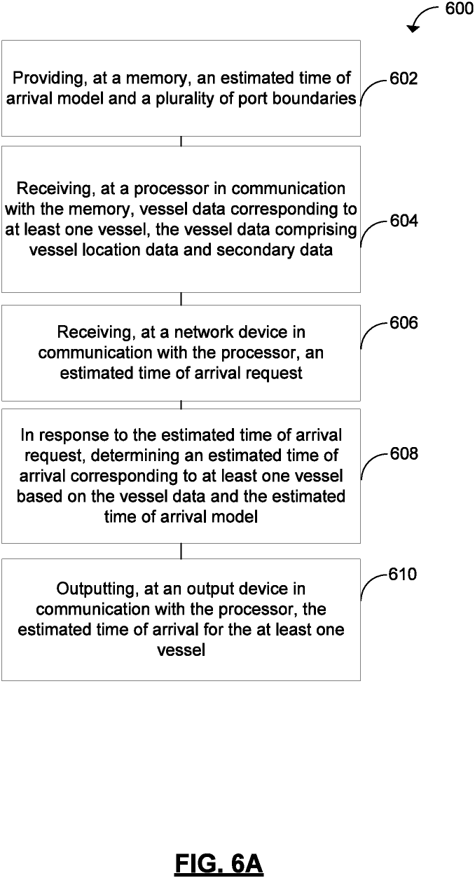

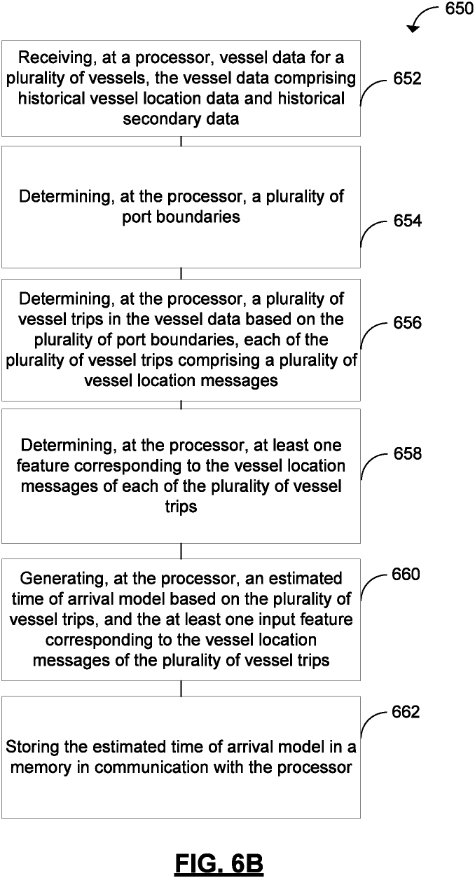

Referring next to FIG. 6A, there is shown a method 600 for determining a vessel estimated time of arrival (ETA) in accordance with one or more embodiments.

At 602, an estimated time of arrival model and a plurality of port boundaries are provided at a memory.

At 604, vessel data corresponding to at least one vessel is received at a processor in communication with the memory, the vessel data comprising vessel location data and secondary data.

At 606, an estimated time of arrival request is received at a network device in communication with the processor.

At 608, in response to the estimated time of arrival request, an estimated time of arrival corresponding to at least one vessel is determined based on the vessel data and the estimated time of arrival model.

At 610, outputting, at an output device in communication with the processor, the estimated time of arrival for the at least one vessel.

Optionally, the estimated time of arrival request may comprise a vessel identifier.

Optionally, the estimated time of arrival request may comprise a port identifier and the estimated time of arrival is determined for one or more vessel having a destination corresponding to the port identifier.

Optionally, the estimated time of arrival corresponding to the at least one vessel may comprise a remaining time of travel.

Optionally, the vessel location data may comprise geospatial data and the secondary data may comprise alphanumeric data, and the geospatial data may be joined with the alphanumeric data prior to the determining the estimated time of arrival corresponding to the at least one vessel.

Optionally, the secondary data may comprise alphanumeric data comprising vessel type data, port congestion data, vessel tonnage data.

Optionally, the determining the estimated time of arrival corresponding to at least one vessel based may be further based on a port boundary.

Optionally, the port boundary may comprise a closed polygon corresponding to the port identifier.

Optionally, the estimated time of arrival model may comprise a plurality of sub-models, each of the plurality of sub-models corresponding to a port.

Optionally, a sub-model in the plurality of sub-models may comprise a regression model, and the determined remaining time of travel for a corresponding port to the sub-model is determined by the regression model based on the vessel data.

Optionally, the regression model may comprise one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

Optionally, the received historical vessel tracking data may comprise at least one of received AIS data and received radiofrequency beacon data.

Optionally, the output device may comprise at least one of an audio output device or a video output device.

Referring next to FIG. 6B, there is shown a method 650 for generating an ETA model in accordance with one or more embodiments.

At 652, vessel data for a plurality of vessels is received at a processor, the vessel data comprising historical vessel location data and historical secondary data.

At 654, a plurality of port boundaries are determined at the processor.

At 656, a plurality of vessel trips in the vessel data are determined at the processor, based on the plurality of port boundaries, each of the plurality of vessel trips comprising a plurality of vessel location messages.

At 658, at least one feature corresponding to the vessel location messages of each of the plurality of vessel trips is determined at the processor.

At 660, an estimated time of arrival model is generated at the processor based on the plurality of vessel trips, and the at least one input feature corresponding to the vessel location messages of the plurality of vessel trips.

At 662, storing the estimated time of arrival model in a memory in communication with the processor.

Optionally, the plurality of port boundaries may correspond to at least one of a port, an anchorage, or a maintenance facility.

Optionally, the determining the plurality of port boundaries may comprise determining the plurality of port boundaries from at least one of a map, a digital satellite image, a digital aerial photograph, and geospatial data.

Optionally, the determining the plurality of port boundaries may comprise determining the plurality of port boundaries based on historical vessel tracking data.

Optionally, each of the plurality of port boundaries may comprise at least one polygon.

Optionally, the at least one polygon may comprise at least two hierarchical levels.

Optionally, the at least one feature may comprise a remaining time of travel.

Optionally, each of the vessel trips may comprise an origin port identifier, a destination port identifier.

Optionally, the method may further comprise: determining, at the processor, a remaining time of travel for each of the plurality of vessel location messages by: identifying the plurality of vessel trips in the historical vessel location data corresponding to the destination port identifier; determining an actual time of arrival for each of the plurality of vessel trips in the historical vessel location data corresponding to the destination port identifier, wherein for each identified vessel trip the actual time of arrival comprises a timestamp corresponding to the vessel entering a destination port boundary associated with the destination port identifier; determining the remaining time of travel for each of the plurality of vessel location messages based on a timestamp associated with each vessel location message and the actual time of arrival for the associated vessel trip, the remaining time of travel comprising a period of time until the vessel arrives at a destination.

Optionally, the actual time of arrival may be determined by: using a spatial selection algorithm to identify at least one vessel location message inside and at least one vessel location message outside of the destination port boundary; sorting the at least one vessel trip location message by its timestamp; selecting the last vessel trip location message of the vessel trip outside the destination port boundary, and the first vessel trip location message inside the port boundary; and applying a weighted interpolation of the timestamps of those two vessel location messages as the actual time of arrival.

Optionally, the method may further comprise: determining a plurality of vessel trip groups, each comprising a subset of the plurality of vessel trips wherein each vessel trip in the subset has the same origin port identifier and the same destination port identifier.

Optionally, the estimated time of arrival model may comprise a plurality of sub-models, each of the plurality of sub-models corresponding to a port.

Optionally, a sub-model in the plurality of sub-models may comprise a regression model, and the determined remaining time of travel for a corresponding port to the sub-model is determined by the regression model based on the vessel data.

Optionally, the regression model may comprise one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

Optionally, the received historical vessel tracking data may comprise at least one of received AIS data and received radiofrequency beacon data.

Optionally, the method may further comprise: determining, at the processor, that a first temporal resolution of the historical vessel location data and a second temporal resolution of the historical secondary data are different; and interpolating one of the historical vessel location data and the historical secondary data.

Optionally, the interpolating may comprise interpolating the historical vessel location data corresponding to each of the plurality of vessel trips based on the historical secondary data, and wherein the historical vessel location data has a first temporal resolution and the historical secondary data has a second temporal resolution, the first temporal resolution lower than the second temporal resolution.

Optionally, the interpolating may comprise interpolating the historical secondary data corresponding to each of the plurality of vessel trips based on the historical vessel location data, and wherein the historical vessel location data has a first temporal resolution and the historical secondary data has a second temporal resolution, the first temporal resolution higher than the second temporal resolution.

Referring next to FIG. 14, there is shown map interface 1400 for port boundary identification in accordance with one or more embodiments. The vessel location messages or trajectory of the vessels may be received and separated into individual trips (port to port) as described herein.

The positional data of the vessel tracking messages may be geospatially joined with different geometric location of ports, marine regions, and Exclusive Economic Zones (EEZ) encoded in shapefiles. A shapefile may be a simple, nontopological format for storing the geometric location and attribute information of geographic features. Geographic features in a shapefile may be represented by points, lines, or polygons (areas).

The marine region and EEZ shapefiles may be similar to those produced by Flander Marine Institute, which maintains a database of international borders in open waters. The EEZ may be modified or adjusted in order to improve data processing performance by reducing the size of the shapefile. This may be achieved by generating a one-way buffer in land for the EEZ. This may simplify the geometry around the coastline and allow for joining of vessel tracking messages that may be immediately at the land boundary. The buffering may also prevent an increase in the extent of a countries EEZ.

The port shapefiles may be generated using a tool, for example the World Port Index ports. The ports may be converted into points and may be buffered to generate port zone shapefiles.

The join operator between the shapefiles and vessel tracking positions may output the corresponding location identification on which each vessel tracking message is reported in. This information may be used for selecting region or geographically specific analysis (including determination of geographically specific profile data).

The vessel tracking data may be joined to a region identifier (Region ID) and a Port identifier (Port ID) to one or more vessel location messages.

A trip for a first vessel is displayed at 1402, including one or vessel location messages. A region ID and a port ID of 0 may identify that the associated vessel tracking data is not associated with a particular region or port respectively. As the vessel proceeds from the ocean into the marine region defined off the coast of Turkey, the vessel location messages may be joined to include geospatial data to indicate that the vessel has entered the Iskenderun port boundary 1406 (noted as Port ID 44880 in port visit location message 1404). The vessel may later move to the Yakacik port boundary 1410, and the vessel tracking data may be joined to indicate that it has entered the port (noted as Port ID 44803 in port visit location message 1408).

The vessel’s track/route may be visualized on a map user interface 1400. The visualization may include an indication of a port visit 1404 that may include a vessel identifier (for example, the MMSI), the port identifier, an actual arrival time of the vessel at the port, and a number of vessel tracking messages which are received.

The second port visit to Yakacik port region may be provided as another indication of a port visit 1108 that may include a vessel identifier (for example, the MMSI), the port identifier, an actual time of arrival at the port, a time of exit into the port, and a number of vessel tracking messages which are received.

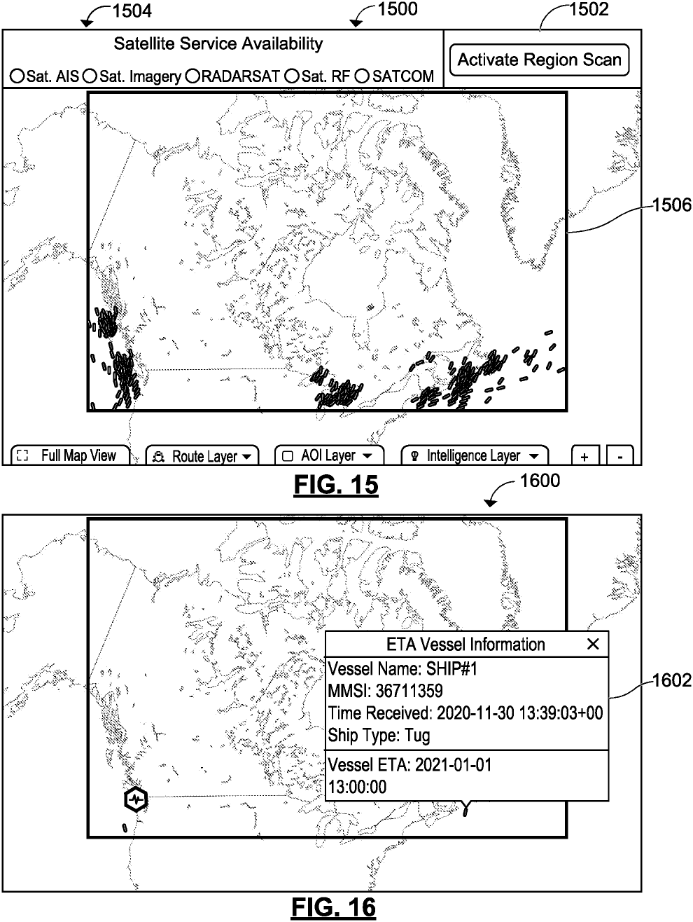

Referring next to FIG. 15, there is shown a user interface diagram 1500 in accordance with one or more embodiments. The user interface 1500 may be generated by the user interface engine 514 (see FIG. 5) and may be provided to an end user by way of a downloaded app on their user device in communication with server 108 (see FIG. 1), or by way of a web interface provided by server 108 (see FIG. 1).

The user interface 1500 may show a map including one or more maritime regions, EEZs or ports and one or more vessels. Communication status 1504 with one or more data providers may be displayed. The user may proceed by selecting the “Activate Region Scan” button 1502 which may begin searching for vessel trips that are underway that may require ETA predictions.

The user interface 1500 may include a selectable box 1506 that may enable a user to select on the map a particular region or regions for the region ETA scan when the “Activate Region Scan” button 1202 is selected.

In an alternate embodiment, the user interface 1500 may show one or more ports on the map. A user may select one or more ports, and may select an “Activate port ETA scan” which may generate an ETA request as described at 462 (see FIG. 4B) to request an ETA prediction for one or more vessels with a future destination of the one or more ports that are selected.

Referring next to FIG. 16, there is shown another user interface diagram 1600 in accordance with one or more embodiments. Responsive to the user’s selection of the “Activate Region Scan” button 1502, vessel ETA predictions may be performed on the one or more vessels in the selected marine region. The user may select a vessel in the Region Scan, and may be presented with an ETA window 1602 summarizing the ETA prediction of the vessel.

For example, the ETA prediction window 1602 shows a vessel name, MMSI, vessel tracking message timestamp, ship type, and vessel ETA prediction.

In an alternate embodiment, another user interface diagram may be shown responsive to the selection of the “Activate Port ETA Scan” button in accordance with one or more embodiments. Responsive to the user’s selection of the “Activate Port ETA Scan” button, vessel ETA predictions for any vessels identifying their destination as the selected one or more ports may be performed. The user interface may display a list of vessels included in the Port ETA Scan in an interface that may be displayed by each selected port, i.e. as an arrivals listing. The user may select an individual vessel in the Port ETA Scan, and may be presented with an ETA window summarizing the vessel’s ETA, including any of the vessel’s location message data associated with it’s in-progress trip.

The present invention has been described here by way of example only. Various modifications and variations may be made to these embodiments without departing from the spirit and scope of the invention, which is limited only by the appended claims.

We claim:

1. A computer-implemented method for determining an estimated time of arrival for a vessel, the method comprising:
providing, at a memory, an estimated time of arrival model and a plurality of port boundaries;
receiving, at a processor in communication with the memory, vessel data corresponding to at least one vessel, the vessel data comprising vessel location data and secondary data;
receiving, at a network device in communication with the processor, an estimated time of arrival request;
in response to the estimated time of arrival request, determining an estimated time of arrival corresponding to at least one vessel based on the vessel data and the estimated time of arrival model;
outputting, at an output device in communication with the processor, the estimated time of arrival for the at least one vessel.

2. The computer-implemented method of claim 1 wherein the estimated time of arrival request comprises a vessel identifier.

3. The computer-implemented method of claim 1 wherein the estimated time of arrival request comprises a port identifier and the estimated time of arrival is determined for one or more vessel having a destination corresponding to the port identifier.

4. The computer-implemented method of claim 3 wherein the estimated time of arrival corresponding to the at least one vessel comprises a remaining time of travel.

5. The computer-implemented method of claim 1 wherein the vessel location data comprises geospatial data and the secondary data comprises alphanumeric data, and the geospatial data is joined with the alphanumeric data prior to the determining the estimated time of arrival corresponding to the at least one vessel.

6. The computer-implemented method of claim 5 wherein the secondary data comprises alphanumeric data comprising vessel type data, port congestion data, vessel tonnage data.

7. The computer-implemented method of claim 1 wherein the determining the estimated time of arrival corresponding to at least one vessel based is further based on a port boundary.

8. The computer-implemented method of claim 7, wherein the port boundary comprises a closed polygon corresponding to the port identifier.

9. The computer-implemented method of claim 1 wherein the estimated time of arrival model comprises a plurality of sub-models, each of the plurality of sub-models corresponding to a port.

10. The computer-implemented method of claim 9 wherein a sub-model in the plurality of sub-models comprises a regression model, and the determined remaining time of travel for a corresponding port to the sub-model is determined by the regression model based on the vessel data.

11. The computer-implemented method of claim 10 wherein the regression model comprises one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

12. The computer-implemented method of claim 1, wherein the received historical vessel tracking data comprises at least one of received AIS data and received radiofrequency beacon data.

13. The computer-implemented method of claim 1, wherein the output device comprises at least one of an audio output device or a video output device.

14. The method of claim 1 wherein the estimated time of arrival is the time of arrival to one or more arbitrary locations in the open ocean or ocean-feeding lake or river in sequence.

15. A system for determining an estimated time of arrival for a vessel, the system comprising:
a memory comprising an estimated time of arrival model and a plurality of port boundaries;
an output device;
a processor in communication with the memory and the output device, the processor configured to:
receive vessel data corresponding to at least one vessel, the vessel data comprising vessel location data and secondary data;
receive an estimated time of arrival request;
in response to the estimated time of arrival request, determine an estimated time of arrival corresponding to at least one vessel based on the vessel data and the estimated time of arrival model;
output, to the output device in communication with the processor, the estimated time of arrival for the at least one vessel.

16. The system of claim 15 wherein the estimated time of arrival request comprises a vessel identifier.

17. The system of claim 15 wherein the estimated time of arrival request comprises a port identifier and the estimated time of arrival is determined for one or more vessel having a destination corresponding to the port identifier.

18. The system of claim 17 wherein the estimated time of arrival corresponding to the at least one vessel comprises a remaining time of travel.

19. The system of claim 15 wherein the vessel location data comprises geospatial data and the secondary data comprises alphanumeric data, and the geospatial data is joined with the alphanumeric data prior to the determining the estimated time of arrival corresponding to the at least one vessel.

20. The system of claim 19 wherein the secondary data comprises alphanumeric data comprising vessel type data, port congestion data, vessel tonnage data.

21. The system of claim 15 wherein the determining the estimated time of arrival corresponding to at least one vessel based is further based on a port boundary.

22. The system of claim 21, wherein the port boundary comprises a closed polygon corresponding to the port identifier.

23. The system of claim 15 wherein the estimated time of arrival model comprises a plurality of sub-models, each of the plurality of sub-models corresponding to a port.

24. The system of claim 23 wherein a sub-model in the plurality of sub-models comprises a regression model, and the determined remaining time of travel for a corresponding port to the sub-model is determined by the regression model based on the vessel data.

25. The system of claim 24 wherein the regression model comprises one of a Lasso Regression model, a Ridge Regression model, a Logistic Regression model, a Random Forest model, a Decision Tree Regression model, a Gradient-Boosted Tree model, a Linear Regression model, a Bayesian Linear Regression model, a Polynomial Regression model, a Robust Regression RANSAC model, an Ordinary Least Squares Regression model, a K-Nearest Neighbor Regression model, a Support Vector Regression model, a Gaussian Process Regression model, a Multilayer Perceptron model, an Artificial Neural Network model, a Deep Neural Network model, a Convolutional Neural Network model, a Recurrent Neural Network model, and a Long Short-Term Memory Network.

26. The system of claim 15, wherein the received historical vessel tracking data comprises at least one of received AIS data and received radiofrequency beacon data.

27. The system of claim 15, wherein the output device comprises at least one of an audio output device or a video output device.

28. The system of claim 15 wherein the estimated time of arrival is the time of arrival to one or more arbitrary locations in the open ocean or ocean-feeding lake or river in sequence.
